(19) United States
(12) Patent Application Publication
(10) Pub. No.: US 2025/0301355 A1
(43) Pub. Date: Sep. 25, 2025

(54) METHOD AND APPARATUS FOR TRANSMITTING INFORMATION, DEVICE, AND STORAGE MEDIUM

(71) Applicant: Beijing Xiaomi Mobile Software Co., Ltd., Beijing (CN)

(72) Inventor: Xueyuan GAO, Beijing (CN)

(21) Appl. No.: 18/860,503

(22) PCT Filed: Apr. 29, 2022
(86) PCT No.: PCT/CN2022/090776

§ 371 Date: Oct. 25, 2024

(51) Int. Cl. H04W 24/10; H04B 7/01

(52) U.S. Cl. CPC H04W 24/10; H04B 7/01

(57) ABSTRACT

A method for transmitting information includes: receiving a tracking reference signal, determining phase information of a transmission path according to the tracking reference signal, and transmitting the phase information to a network device.

### CROSS-REFERENCE TO RELATED APPLICATIONS

The present application is a U.S. National Stage of International Application No. PCT/CN2022/090776, filed on PCT Apr. 29, 2022, the contents of all of which are incorporated herein by reference in their entireties for all purposes.

### BACKGROUND

In a new radio (NR) system, a Doppler shift of a terminal device are required for estimating channel information by a network device. However, due to limitation of an uplink pilot density, the network device fails to estimate accurate the Doppler shift based on an existing uplink pilot signal.

### SUMMARY

The disclosure relates to the technical field of communication, and particularly relates to a method and apparatus for transmitting information, a device, and a storage medium.

In a first aspect, an example of the disclosure provides a method for transmitting information. The method is performed by a terminal device. The method includes: receiving a tracking reference signal; determining phase information of a transmission path according to the tracking reference signal; and transmitting the phase information to a network device.

In a second aspect, an example of the disclosure provides another method for transmitting information. The method is performed by a network device. The method includes: transmitting a tracking reference signal to a terminal device; receiving phase information of a transmission path transmitted by the terminal device; and determining channel information according to the phase information.

In a third aspect, an example of the disclosure provides a communication apparatus. The communication apparatus includes one or more processors. When a computer program in a memory is invoked, the method for transmitting information according to the first aspect are executed by the one or more processors.

In a fourth aspect, an example of the disclosure provides a communication apparatus. The communication apparatus includes one or more processors. When a computer program in a memory is invoked, the method for transmitting information according to the second aspect are executed by the one or more processors.

In a fifth aspect, an example of the disclosure provides a communication apparatus. The communication apparatus includes one or more processors and a memory. A computer program is stored in the memory. The computer program stored in the memory is executed by the one or more processors, such that the method for transmitting information according to the first aspect is executed by the communication apparatus.

In a sixth aspect, an example of the disclosure provides a communication apparatus. The communication apparatus includes one or more processors and a memory. A computer program is stored in the memory. The computer program stored in the memory is executed by the one or more processors, such that the method for transmitting information according to the second aspect is executed by the communication apparatus.

In a seventh aspect, an example of the disclosure provides a communication apparatus. The communication apparatus includes one or more processors and an interface circuit. The interface circuit is configured to receive a code instruction and transmit the code instruction to the one or more processors. The one or more processors are collectively configured to run the code instruction such that the method for transmitting information according to the first aspect is executed by the communication apparatus.

In an eighth aspect, an example of the disclosure provides a communication apparatus. The communication apparatus includes one or more processors and an interface circuit. The interface circuit is configured to receive a code instruction and transmit the code instruction to the one or more processors. The one or more processors are collectively is configured to run the code instruction such that the method for transmitting information according to the second aspect is executed by the communication apparatus.

In a ninth aspect, an example of the disclosure provides a communication system. The communication system includes the communication apparatus according to the third aspect and the communication apparatus according to the fourth aspect. Alternatively, the communication system includes the communication apparatus according to the fifth aspect and the communication apparatus according to the sixth aspect. Alternatively, the communication system includes the communication apparatus according to the seventh aspect and the communication apparatus according to the eighth aspect.

In a tenth aspect, an example of the disclosure provides a non-transitory computer-readable storage medium. The computer-readable storage medium is configured to store an instruction used by the terminal device. When the instruction is executed, the method for transmitting information according to the first aspect is executed by the terminal device.

In an eleventh aspect, an example of the disclosure provides a non-transitory computer-readable storage medium. The computer-readable storage medium is configured to store an instruction used by the network device. When the instruction is executed, the method for transmitting information according to the second aspect is executed by the network device.

In a twelfth aspect, the disclosure further provides a computer program product including a computer program. When the computer program product runs on a computer, the method for transmitting information according to the first aspect is executed by the computer.

In a thirteen aspect, the disclosure further provides a computer program product including a computer program. When the computer program product runs on a computer, the method for transmitting information according to the second aspect is executed by the computer.

In a fourteen aspect, the disclosure provides a chip system. The chip system includes at least one processor and an interface, and is configured to support a terminal device to achieve the functions involved in the first aspect, and for example, a function of determining or processing at least one of data and information involved in the above method.

In a fifteenth aspect, the disclosure provides a chip system. The chip system includes at least one processor and an interface, and is configured to support a network device to achieve the functions involved in the second aspect, and for example, a function of determining or processing at least one of data and information involved in the above method.

In a sixteenth aspect, the disclosure provides a computer program. When the computer program runs on a computer, the method for transmitting information according to the first aspect is executed by the computer.

In a seventeenth aspect, the disclosure provides a computer program. When the computer program runs on a computer, the method for transmitting information according to the second aspect is executed by the computer.

### BRIEF DESCRIPTION OF DRAWINGS

In order to more clearly describe technical solutions in examples of the disclosure or the background art, the accompanying drawings required for the examples of the disclosure or the background art will be illustrated below.

FIG. 1 is a schematic diagram of a framework of a communication system according to an example of the disclosure;

FIG. 2 is a schematic flow diagram of a method for transmitting information according to an example of the disclosure;

FIG. 3 is a schematic flow diagram of another method for transmitting information according to an example of the disclosure;

FIG. 4 is a schematic flow diagram of another method for transmitting information according to an example of the disclosure;

FIG. 5 is a schematic flow diagram of yet another method for transmitting information according to an example of the disclosure;

FIG. 6 is a schematic flow diagram of yet another method for transmitting information according to an example of the disclosure;

FIG. 7 is a schematic flow diagram of yet another method for transmitting information according to an example of the disclosure;

FIG. 8 is a schematic flow diagram of yet another method for transmitting information according to an example of the disclosure;

FIG. 9 is a schematic flow diagram of still another method for transmitting information according to an example of the disclosure;

FIG. 10 is a schematic flow diagram of still another method for transmitting information according to an example of the disclosure;

FIG. 11 is a schematic flow diagram of still another method for transmitting information according to an example of the disclosure;

FIG. 12 is a schematic flow diagram of still another method for transmitting information according to an example of the disclosure;

FIG. 13 is a schematic flow diagram of still another method for transmitting information according to an example of the disclosure;

FIG. 14 is a schematic flow diagram of still another method for transmitting information according to an example of the disclosure;

FIG. 15 is a schematic flow diagram of still another method for transmitting information according to an example of the disclosure;

FIG. 16 is a schematic structural diagram of an apparatus for transmitting information according to an example of the disclosure;

FIG. 17 is a schematic structural diagram of an apparatus for transmitting information according to an example of the disclosure;

FIG. 18 is a schematic structural diagram of communication apparatus according to an example of the disclosure; and

FIG. 19 is a schematic structural diagram of a chip according to an example of the disclosure.

### DETAILED DESCRIPTION

Examples will be described in detail here and shown in the accompanying drawings illustratively. When the following descriptions involve the accompanying drawings, unless otherwise specified, a same number in different accompanying drawings denotes the same or similar elements. The embodiments described in the following examples do not denote all embodiments consistent with the examples of the disclosure. On the contrary, the embodiments are merely instances of an apparatus and a method consistent with some aspects of the examples of the disclosure as detailed in the appended claims.

The terms used in the examples of the disclosure are merely to describe the specific examples, instead of limiting the examples of the disclosure. The singular forms such as “a”, “an” and “the” used in the examples of the disclosure and the appended claims are also intended to include the plural forms, unless otherwise clearly stated in the context. It is to be further understood that the term “and/or” used here refers to and includes any of one or more of the associated listed items or all possible combinations.

It is to be understood that although the terms such as first, second and third may be used to describe various information in the examples of the disclosure, the information is not to be limited to the terms. The terms are merely used to distinguish the same type of information from each other. For example, without departing from the scope of the examples of the disclosure, first information may also be referred to as second information, and similarly, second information may also be referred to as first information. Depending on the context, the word “if” as used here can be interpreted as “when” or “at the time of” or “in response to determining”.

In the related art, the terminal device is generally used to determine the Doppler shift of a transmission path and convert the Doppler shift into an integer part and a decimal part. The integer part and the decimal part are separately quantified for indication, such that the Doppler shift of the transmission path are reported to the network device, and the channel information is estimated by the network device in time.

In this way, when the terminal device reports the Doppler shift of the transmission path to the network device, a huge amount of feedback indication overhead will be consumed, and information transmission efficiency will be influenced.

Examples of the disclosure provide a method and apparatus for transmitting information, a device, a chip system, a storage medium, a computer program, and a computer program product, which are applicable to the technical field of communication. Reference is made to a tracking reference signal by a terminal device, such that phase information of a transmission path is determined. The phase information is configured to describe a phase condition corresponding to a Doppler shift of the transmission path. Then, the phase information is transmitted to a network device, such that channel information is determined by the network device based on the phase information. As data conversion and quantified for indication are not required for the Doppler shift of the transmission path, feedback indication overhead can be effectively reduced, and information transmission efficiency can be improved.

In order to facilitate understanding, the terms involved in the disclosure will be firstly introduced.

### 1. Tracking Reference Signal (TRS)

The tracking reference signal is a known signal configured for time-frequency tracking in a communication system, and may be configured by a network device for a terminal device and transmitted. A Doppler shift corresponding to each transmission path may be determined by the terminal device according to the received tracking reference signal, and the Doppler shift may be transmitted to the network device, such that future downlink channel information may be predicted by the network device. In this case, reference information may be provided for prediction of channel information of the network device by the tracking reference signal.

### 2. Transmission Path

The transmission path is a communication path configured to transmit information between the terminal device and the network device.

### 3. Phase Information

The phase information may be configured to describe a phase condition corresponding to the Doppler shift of the transmission path. The phase information may be, for example, a phase difference or a phase deflection value of the transmission path.

### 4. Channel Information

The channel information is information for describing a communication status of a channel. The channel information may be, for example, coherence time information of the channel (coherence time is configured to indicate a maximum time difference range in which the channel remains constant), or fading status information configured to describe signal transmission on the channel. The channel information may be determined by the network device based on the phase information reported by the terminal device.

For better understanding of a method for transmitting information according to the examples of the disclosure, a communication system applicable to the examples of the disclosure will be firstly described below.

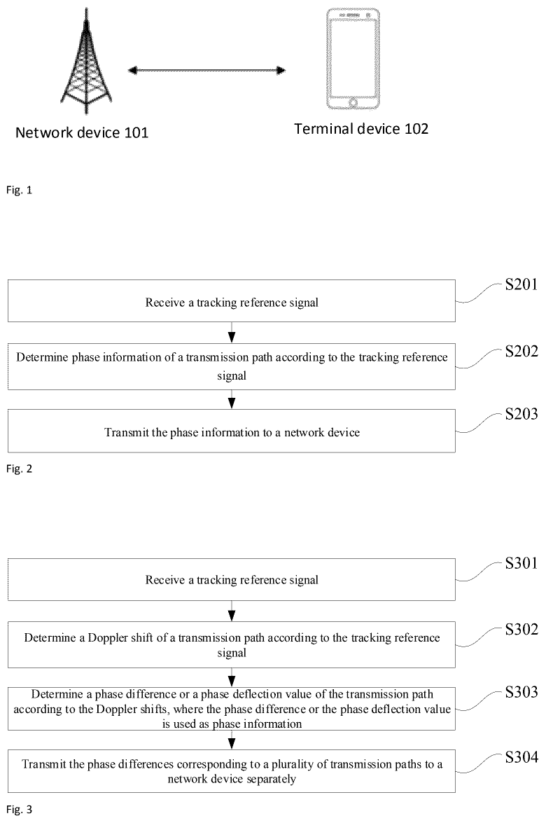

With reference to FIG. 1, FIG. 1 is a schematic diagram of a framework of a communication system according to an example of the disclosure. The communication system may include, but is not limited to, one network device and one terminal device. A number and a form of the devices shown in FIG. 1 are illustrative and do not limit the examples of the disclosure. In practical application, the communication system may include two or more network devices and two or more terminal devices. For example, the communication system shown in FIG. 1 may include one network device 101 and one terminal device 102.

It is to be noted that technical solutions of the examples of the disclosure may be applied to various communication systems, such as a long term evolution (LTE) system, a 5th generation (5G) mobile communication system, a 5G new radio (NR) system, or other novel mobile communication systems in the future.

The network device 101 in the example of the disclosure is an entity configured to transmit or receive a signal on a network side. For example, the network device 101 may be an evolved NodeB (eNB), a transmission reception point (TRP), a next generation NodeB (gNB) in the NR system, a base station in other future mobile communication systems, or an access node in a wireless fidelity (WiFi) system. The example of the disclosure does not limit specific technologies and specific device forms used by the network device.

The network device according to the example of the disclosure may be composed of a central unit (CU) and a distributed unit (DU). The CU may also be referred to as a control unit. With a structure of CU-DU, protocol layers of the network device, for example, a base station, may be separated. Functions of some protocol layers are centrally controlled by the CU while functions of the other or all protocol layers are distributed in the DU, and the DU is centrally controlled by the CU.

The terminal device 102 in the example of the disclosure is an entity, for example, a mobile phone, configured to receive or transmit a signal on a user side. The terminal device may also be referred to as a terminal, user equipment (UE), a mobile station (MS), a mobile terminal (MT), etc. The terminal device may be a vehicle having a communication function, an intelligent vehicle, a mobile phone, a wearable device, Pad, a computer having a radio transceiving function, a virtual reality (VR) terminal device, an augmented reality (AR) terminal device, a radio terminal device in industrial control, a radio terminal device in self-driving, a radio terminal device in remote medical surgery, a radio terminal device in smart grid, a radio terminal device in transportation safety, a radio terminal device in smart city, a radio terminal device in smart home, etc.

The example of the disclosure does not limit specific technologies and specific device forms used by the terminal device.

In an information transmission process of the communication system, a Doppler shift of a transmission path may be determined by the terminal device 102 according to a tracking reference signal transmitted by the network device 101, and the Doppler shift may be fed back to the network device 101 according to a certain strategy, such that future downlink channel information may be predicted by the network device 101 according to the Doppler shift. The terminal device according to the example of the disclosure may be the terminal device 102, and the network device according to the example of the disclosure may be the network device 101.

It may be understood that the communication system according to the example of the disclosure is intended to describe the technical solution of the example of the disclosure more clearly, instead of limiting the technical solution according to the example of the disclosure. Those of ordinary skill in the art may know that the technical solution according to the example of the disclosure is also applicable to similar technical problems with evolution of a system structure and emergence of new business cases.

The method and apparatus for transmitting information according to the disclosure will be described in detail with reference to the accompanying drawings below.

FIG. 2 is a schematic flow diagram of a method for transmitting information according to an example of the disclosure. The method is performed by a terminal device. The method for transmitting information in the example is applicable to the terminal device, and for example, a mobile phone, a tablet computer and a smart watch, etc. having a mobile communication function, which is not limited here.

As shown in FIG. 2, the method may include, but is not limited to, the following steps:

S201: a tracking reference signal is received.

Where the tracking reference signal (TRS) is a known signal configured for time-frequency tracking in a communication system.

The tracking reference signal may be configured by the network device and transmitted to the terminal device. A Doppler shift corresponding to each transmission path may be determined by the terminal device according to the received tracking reference signal, and the Doppler shift may be transmitted to the network device, such that future downlink channel information may be predicted by the network device. In this case, reference information may be provided for prediction of channel information of the network device by the tracking reference signal.

In the example of the disclosure, the tracking reference signal may be configured by the network device for a terminal, and the tracking reference signal may be transmitted to the terminal device. The tracking reference signal configured and transmitted by the network device is received by the terminal device. Then, phase information of the transmission path may be determined by the terminal device according to the tracking reference signal. Thus, efficient feedback indication of the Doppler shift can be implemented. Reference may be made to the following steps for details.

S202: the phase information of the transmission path is determined according to the tracking reference signal.

The transmission path is a communication path configured to transmit information between the terminal device and the network device. The transmission path may be a transmission channel in the communication system.

The phase information may be configured to describe a phase condition corresponding to the Doppler shift of the transmission path. The phase information may be, for example, a phase difference or a phase deflection value of the transmission path.

The phase difference may be configured to describe the phase situation corresponding to the Doppler shift, and is a phase difference caused by a time difference in the Doppler shift. That is, a value range of the phase difference may be constrained by the above time difference. Reference may be made to the following examples for a specific constraint relation.

The phase deflection value may be configured to describe the phase condition corresponding to the Doppler shift. That is, phase shift corresponding to the Doppler shift may be referred to as the phase deflection value.

Clearly, the phase information may also be any other information configured to describe the phase condition corresponding to the Doppler shift, and for example, a phase shift rate, an average phase deflection value, etc., which is not limited here.

The channel information is communication data information for describing a communication status of a channel.

The channel information may be, for example, coherence time information of the channel (coherence time is configured to indicate a maximum time difference range in which the channel remains constant), or fading status information configured to describe signal transmission on the channel. The channel information may be determined by the network device based on the phase information reported by the terminal device.

In the example of the disclosure, a plurality of transmission paths may be provided. Accordingly, a plurality of pieces of phase information corresponding to the transmission paths may be provided.

In the example of the disclosure, after the tracking reference signal is received by the terminal device, the phase shift rate, the average phase deflection value, the phase difference or the phase deflection value corresponding to each of the transmission paths may be determined as the phase information according to the tracking reference signal, which is not limited here.

In the example of the disclosure, when the phase information of the transmission path is determined according to the tracking reference signal, time-frequency tracking processing may be conducted on data signals on the transmission path based on the tracking reference signal, and phase deflection value of the data signals on the transmission path may be measured, such that the phase deflection value of the transmission path is obtained. Moreover, the phase deflection value may be used as the phase information of the transmission path.

In the example of the disclosure, set duration may also be preset, a corresponding phase value of the data signal on the transmission path within start time of the set duration may be determined according to the tracking reference signal, phase difference information of the transmission path may be computed according to the phase value, and the phase difference information may be determined as the phase information of the transmission path, such that the phase information of the transmission path may be determined according to the tracking reference signal, which is not limited here.

In the example of the disclosure, the phase information of the transmission path may be determined with reference to the tracking reference signal, and the determined phase information may be reported to the network device by the terminal device. After the phase information is received by the network device, the Doppler shift may be restored according to the phase information, such that the future downlink channel information may be predicted by the network device.

S203: the phase information is transmitted to the network device.

In the example of the disclosure, after the phase information of the transmission path is determined according to the tracking reference signal, the phase information may be transmitted to the network device by the terminal device.

In the example of the disclosure, when the phase information is transmitted to the network device, the phase difference of the transmission path may be transmitted to the network device by the terminal device, or the phase deflection value of the transmission path may be transmitted to the network device by the terminal device.

In the example of the disclosure, the phase information of the transmission path is determined according to the tracking reference signal, and the phase information is transmitted to the network device, such that reliable reference information can be provided for the network device in future channel information prediction, and communication performance of the communication system can be guaranteed.

In the example, reference is made to the tracking reference signal by the terminal device, such that the phase information of the transmission path is determined. The phase information is configured to describe the phase condition corresponding to the Doppler shift of the transmission path. Then, the phase information is transmitted to the network device, such that the channel information is determined by the network device based on the phase information. As data conversion and quantified for indication are not required for the Doppler shift of the transmission path, feedback indication overhead can be effectively reduced, and information transmission efficiency can be improved.

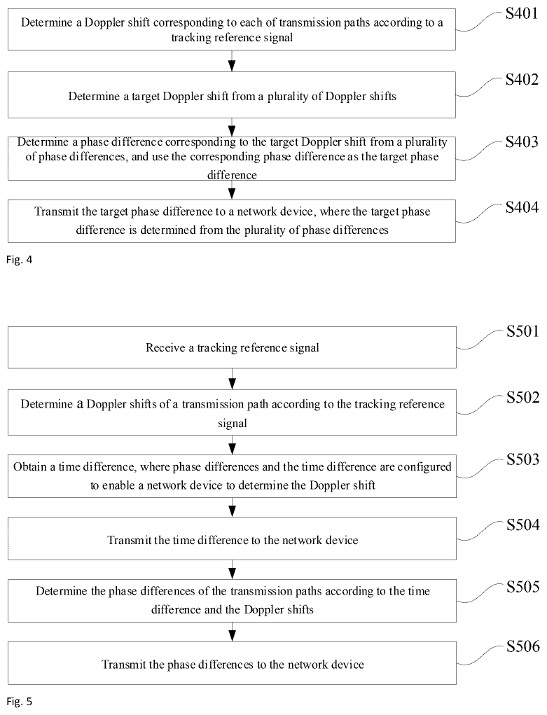

FIG. 3 is a schematic flow diagram of another method for transmitting information according to an example of the disclosure. The method for transmitting information in the example is performed by a terminal device. As shown in FIG. 3, the method may include, but is not limited to, the following steps:

S301: a tracking reference signal is received.

Reference may be made to the description of the above example for detailed introduction of S301, which will not be repeated in the example of the disclosure.

S302: a Doppler shift of a transmission path is determined according to the tracking reference signal.

The Doppler shift are signal carrier shift information on the transmission path caused by relative movement between the terminal device and a network device. The Doppler shift may be determined by the terminal device according to the tracking reference signal.

In the example of the disclosure, when the Doppler shift of the transmission path are determined according to the tracking reference signal, Doppler shift information corresponding to the transmission path may be determined by the terminal device through a power delay profile (PDP) according to the received tracking reference signal, and the determined Doppler shift information may be used as the Doppler shift of the transmission path.

S303: a phase difference or a phase deflection value of the transmission path are determined according to the Doppler shift, where the phase difference or the phase deflection value is used as the phase information.

A plurality of transmission paths are provided. Each of the transmission paths has the corresponding phase difference.

The phase difference may be configured to describe the phase situation corresponding to the Doppler shift, and is a phase difference caused by a time difference in the Doppler shift. That is, a value range of the phase difference may be constrained by the above time difference. Reference may be made to the following examples for a specific constraint relation.

The phase deflection value may be configured to describe the phase condition corresponding to the Doppler shift. That is, phase shifts corresponding to the Doppler shift may be referred to as the phase deflection value.

In the example of the disclosure, after the Doppler shifts of the transmission paths are determined according to the tracking reference signal, the phase differences or phase deflection values of the transmission paths may be determined according to the Doppler shifts, and the determined phase differences or phase deflection values may be used as the phase information. Then, the phase information may be transmitted to the network device by the terminal device. That is, when the phase information is transmitted to the network device by the terminal device, the phase difference of each of the transmission paths may be transmitted to the network device. Alternatively, the phase deflection values of the transmission paths may be transmitted to the network device.

In the example of the disclosure, when the phase differences of the transmission paths are determined according to the Doppler shifts, a computation formula of the Doppler shifts may be determined, and the time difference configured to constrain the phase differences of the transmission paths may be determined. The phase differences of the transmission paths may be determined according to the computation formula of the Doppler shifts and the time difference.

In the example of the disclosure, when the phase deflection values of the transmission paths are determined according to the Doppler shifts, a computation formula corresponding to the phase deflection values and parameter values related to the computation formula of the phase deflection values may be determined, and the phase deflection values may be determined according to the computation formula corresponding to the phase deflection values and the parameter values related to the computation formula of the phase deflection values.

In the example of the disclosure, after the phase differences or the phase deflection values of the transmission paths are determined, the phase differences or the phase deflection values may be used as the phase information, and then the phase differences or the phase deflection values may be transmitted to the network device as the phase information.

S304: the phase differences corresponding to a plurality of transmission paths are transmitted to the network device separately.

In the example of the disclosure, after the phase differences of the transmission paths are determined according to the Doppler shifts, the phase differences corresponding to a plurality of transmission paths may be transmitted to the network device separately.

In the example of the disclosure, when the phase differences corresponding to a plurality of transmission paths are transmitted to the network device separately, the phase difference corresponding to each of the transmission paths may be quantified for indication and reported, and a corresponding indication message may be generated. One indication message may be generated according to the phase difference corresponding to each of the transmission paths, or indication messages corresponding to each of the transmission paths may be generated separately. That is, a same number of indication messages as the transmission paths are generated, and the indication messages are carried in channel status information (CSI), such that the channel status information (CSI) may be transmitted to the network device, and an indication message of the phase difference corresponding to each of the transmission paths may be carried by the channel status information (CSI) and transmitted to the network device.

An example of the disclosure provides a method for transmitting information. A plurality of phase differences are transmitted to a network device separately as follows: each of the phase differences is quantified based on a first bit number, a first quantified result value corresponding to each of the phase differences is obtained, a first indication message is generated according to a plurality of the first quantified result values, and the first indication message is transmitted to the network device. In this way, a plurality of phase differences may be quantified, and the indication message may be generated and transmitted to the network device, such that transmission overhead of communication information can be effectively reduced, and indication efficiency and an indication effect of the phase differences can be improved. After the first indication message is received by the network device, the first indication message may be parsed, and the phase differences corresponding to a plurality of transmission paths may be obtained for restoring Doppler shifts, such that accuracy of the Doppler shifts restored by the network device can be ensured.

The first bit number is a number of bits occupied by transmission of the indication message generated by quantifying the phase difference.

The first quantified result value is a result value obtained by quantifying the phase difference based on the first bit number.

The first indication message is an indication message configured to indicate the phase difference corresponding to each of the transmission paths to the network device. The corresponding indication message may be generated according to the first quantified result value.

In the example of the disclosure, when a plurality of phase differences are transmitted to the network device, the phase difference of each of the transmission paths may be quantified, and the phase difference of each of the transmission paths may be quantified separately based on L bits. The number L of bits may be used as the first bit number, and a value of the first bit number L may be 3 or 4. That is, each phase difference may be quantified with 3 or 4 bits, and a corresponding quantified value may be used as the first quantified result value.

In the example of the disclosure, after each phase difference is quantified based on the first bit number and each corresponding first quantified result value is obtained, the corresponding first indication message may be generated according to each first quantified result value. One indication message may be generated according to each first quantified result value, and the generated indication message may be used as a first indication message. Alternatively, the corresponding first indication message may be generated according to each first quantified result value, then the first indication message may be transmitted to the network device, and one first indication message may be carried by channel status information (CSI). Alternatively, the first indication message corresponding to each first quantified result value may be carried by the channel status information (CSI). And the channel status information (CSI) may be transmitted to the network device, and the first indication message may be transmitted to the network device by channel state information (CSI) carrying the first indication message.

In the example, the Doppler shifts of the transmission paths are determined according to the tracking reference signal, and the phase differences or the phase deflection values of the transmission paths are determined according to the Doppler shifts, where the phase differences or the phase deflection values are used as the phase information. Then, the phase differences or the phase deflection values are transmitted to the network device. As the phase differences or the phase deflection values of the transmission paths are directly determined according to the Doppler shifts of the transmission paths, efficiency of determining the phase information of the transmission paths can be effectively improved. As the phase differences or the phase deflection values are processed and quantified for indication, feedback indication overhead can be greatly reduced. When a plurality of phase differences are transmitted to the network device separately, the Doppler shifts corresponding to the transmission paths may be conveniently restored by the network device based on each phase difference, such that accuracy of channel information estimation can be guaranteed.

FIG. 4 is a schematic flow diagram of yet another method for transmitting information according to an example of the disclosure. The method for transmitting information in the example is performed by a terminal device. As shown in FIG. 4, the method may include, but is not limited to, the following steps:

S401: a Doppler shift corresponding to each of transmission paths is determined according to a tracking reference signal.

In the example of the disclosure, when the Doppler shift corresponding to each of the transmission paths is determined, Doppler shift information corresponding to each of the transmission paths may be determined by the terminal device through a power delay profile (PDP) according to the received tracking reference signal, and the determined Doppler shift information may be used as the Doppler shift of the corresponding transmission path.

S402: a target Doppler shift is determined from a plurality of Doppler shifts.

The target Doppler shift is a Doppler shift determined from a plurality of Doppler shifts and configured to determine a phase difference to be transmitted to the network device. For example, the Doppler shift may be a maximum Doppler shift of the plurality of Doppler shifts. Alternatively, an average value of the plurality of Doppler shifts may be computed as the target Doppler shift.

In the example of the disclosure, when the target Doppler shift is determined from the plurality of Doppler shifts, the maximum Doppler shift may be determined from the plurality of Doppler shifts as the target Doppler shift, and alternatively, the average value of the plurality of Doppler shifts may be computed as the target Doppler shift.

An example of the disclosure provides a method for transmitting information. The target Doppler shift is determined from the plurality of Doppler shifts as follows: a maximum Doppler shift is determined from the plurality of Doppler shifts, where the maximum Doppler shift is used as the target Doppler shift; and alternatively, an average Doppler shift is determined from the plurality of Doppler shifts, where the average Doppler shift is used as the target Doppler shift. Flexibility of selecting the target Doppler shift can be effectively improved, a method for determining the phase difference can be effectively applied to personalized communication scenes, applicability of the method for transmitting information can be improved, and application and expansion of the method for transmitting information can be facilitated.

In the example of the disclosure, when the target Doppler shift is determined from the plurality of Doppler shifts, the maximum Doppler shift may be determined from the plurality of Doppler shifts, and the plurality of Doppler shifts may be numerically compared. A maximum value is determined from the plurality of Doppler shifts as the maximum Doppler shift, and the maximum Doppler shift is used as the target Doppler shift.

For instance, according to the tracking reference signal, Doppler shifts of 3 transmission paths may be determined as Doppler shift A, Doppler shift B, and Doppler shift C respectively, the Doppler shift A, the Doppler shift B and the Doppler shift C may be compared in value, the Doppler shift with a maximum value among the Doppler shift A, the Doppler shift B and the Doppler shift C may be selected as the maximum Doppler shift, and the maximum Doppler shift may be used as the target Doppler shift.

In the example of the disclosure, when the target Doppler shift is determined from the plurality of Doppler shifts, the average Doppler shift may be determined from the plurality of Doppler shifts, and the average value corresponding to the plurality of Doppler shifts may be computed. The average value is used as the average Doppler shift, and the average Doppler shift is used as the target Doppler shift.

For example, according to the tracking reference signal, Doppler shifts of 3 transmission paths may be determined as Doppler shift A, Doppler shift B, and Doppler shift C respectively, an average value of the Doppler shift A, the Doppler shift B and the Doppler shift C may be computed, the average value may be used as the average Doppler shift, and the average Doppler shift of the Doppler shift A, the Doppler shift B and the Doppler shift C may be used as the target Doppler shift.

S403: a phase difference corresponding to the target Doppler shift is determined from a plurality of phase differences, and the corresponding phase difference is used as the target phase difference.

The phase difference corresponding to the target Doppler shift in the plurality of phase differences may be referred to as the target phase difference.

In the example of the disclosure, matching processing is conducted on the plurality of phase differences and the target Doppler shift, such that the phase difference corresponding to the target Doppler shift may be determined from the plurality of phase differences, and the corresponding phase difference may be used as the target phase difference.

For example, when the target Doppler shift is the maximum Doppler shift of the plurality of Doppler shifts, a phase difference corresponding to the maximum Doppler shift may be determined as the target phase difference. Alternatively, when the target Doppler shift is the average Doppler shift of the plurality of Doppler shifts, the phase difference corresponding to Doppler shifts closest to the average Doppler shift may be determined from the plurality of Doppler shifts and used as the target phase difference.

S404: a target phase difference is transmitted to the network device, where the target phase difference is determined from the plurality of phase differences.

The target phase difference is determined from the plurality of phase differences. The target phase difference may be the phase difference corresponding to the target Doppler shift in the plurality of phase differences.

In the example of the disclosure, after the phase difference corresponding to the target Doppler shift is determined from the plurality of phase differences as the target phase difference, the target phase difference may be transmitted to the network device, the target phase difference may be quantified, and a corresponding indication message may be generated. The indication message is transmitted to the network device, such that the target phase difference may be transmitted to the network device.

An example of the disclosure provides a method for transmitting information. The target phase difference is transmitted to the network device as follows: the target phase difference is quantified based on a first bit number, a second quantified result value is obtained, a second indication message is generated according to the second quantified result value, and the second indication message is transmitted to the network device. In this way, the target phase difference may be quantified, and the corresponding indication message may be generated. As the indication message may be carried in channel status information so as to be transmitted, a huge amount of communication resources can be prevented from being occupied, and communication efficiency can be guaranteed. After the second indication message is received by the network device, the target phase difference may be restored according to the second quantified result value in the second indication message, such that accuracy of transmission of the target phase difference can be ensured.

The first bit number is a number of bits occupied for quantifying the target phase difference. The first bit number may be expressed as L, and a value of L may be 3 or 4. That is, 3 bits or 4 bits may be used to quantify the target phase difference.

The second quantified result value is a result value obtained by quantifying the target phase difference based on the first bit number.

The second indication message is an indication message configured to indicate corresponding to target phase difference to the network device. The indication message corresponding to the target phase difference may be generated according to the second quantified result value.

In the example of the disclosure, when the target phase difference is transmitted to the network device, the target phase difference may be quantified, and L bits may be set to quantify the target phase difference. The number L of bits may be used as the first bit number, and a value of the first bit number L may be 3 or 4. That is, the target phase difference may be quantified with 3 or 4 bits, and a corresponding quantified value may be used as the second quantified result value.

In the example of the disclosure, after the target phase difference is quantified based on the first bit number and the second quantified result value is obtained, the second indication message may be generated according to the second quantified result value, and the second indication message may be transmitted to the network device. Channel status information (CSI) may be transmitted to the network device, and the second indication message is carried by the channel status information (CSI). The second indication message is transmitted to the network device, and the second indication message includes the second quantified result value. After the second indication message is received by the network device, the corresponding target phase difference may be determined according to the second quantified result value in the second indication message.

In the example, a plurality of Doppler shifts corresponding to the plurality of transmission paths are determined according to the tracking reference signal, the target Doppler shift is determined from the plurality of Doppler shifts, the phase difference corresponding to the target Doppler shift is determined from the plurality of phase differences, the corresponding phase difference is used as the target phase difference, and the target phase difference is transmitted to the network device. In this way, the phase condition corresponding to the Doppler shifts of the transmission paths can be accurately reflected by the determined phase difference, computation overhead of the phase differences can be reduced, and information processing efficiency can be improved.

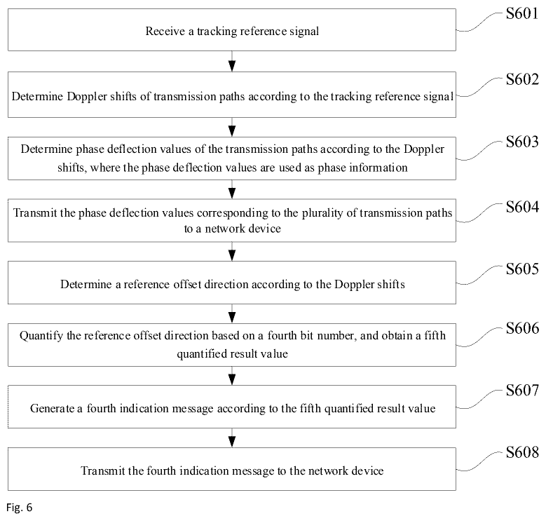

FIG. 5 is a schematic flow diagram of yet another method for transmitting information according to an example of the disclosure. The method for transmitting information in the example is performed by a terminal device. As shown in FIG. 5, the method may include, but is not limited to, the following steps:

S501: a tracking reference signal is received.

S502: a Doppler shift of a transmission path is determined according to the tracking reference signal.

Reference may be made to the description of the above example for detailed introduction of S501 and S502, which will not be repeated in the example of the disclosure.

S503: a time difference is obtained, where phase differences and the time difference are configured to enable a network device to determine the Doppler shift.

The time difference and the phase differences may be configured to enable the network device to determine the Doppler shift.

In the example of the disclosure, when the time difference is obtained, the time difference may be determined by a network device or the terminal device, or the time difference may be negotiated by the network device and the terminal device. Alternatively, the corresponding time difference may be computed through a computation formula of the time difference, and a predefined time difference may be used, which is not limited here.

An example of the disclosure provides a method for transmitting information. The time difference is obtained by any one of the following methods: the time difference transmitted by the network device is received, a Doppler spread of the terminal device is determined, the time difference is determined according to the Doppler spread, the time difference is determined according to the tracking reference signal, and the preset time difference is obtained. More modes of obtaining the time difference are set, such that flexibility of obtaining the time difference can be effectively improved, and the mode of determining the time difference can be effectively applied to personalized communication scenes. As both the network device and the terminal device may participate in setting of the time difference, it can be guaranteed that setting of the time difference can satisfy a communication requirement between the terminal device and the network device, and a communication effect can be guaranteed.

The Doppler spread Ds may be determined by the terminal device, and then the Doppler spread Ds may be reported to the network device by the terminal device. Alternatively, the Doppler spread Ds may be determined by the network device, and the Doppler spread Ds may be transmitted to the terminal device by a network side through downlink signaling.

In the example of the disclosure, when the time difference is obtained, the time difference Δt may be determined by the network device, and the time difference Δt may be transmitted to the terminal device by the network device, such that the time difference may be obtained. The phase differences and the time difference may be configured to enable the network device to determine the Doppler shifts.

In some examples, when the time difference is obtained, the Doppler spread Ds of the terminal device may be determined. The Doppler spread Ds may be determined by the terminal device, or the Doppler spread Ds may be determined by the network device. Then, the computation formula of the time difference related to the Doppler spread Ds may be introduced, and the time difference may be computed according to the computation formula of the time difference and the Doppler spread Ds.

An example of the disclosure provides a method for transmitting information. The Doppler spread of the terminal device is determined as follows: a moving speed of the terminal device is determined, a wavelength of a downlink channel carrier is determined, and the Doppler spread is determined according to the moving speed and the wavelength of the downlink channel carrier. The corresponding Doppler spread is determined according to the moving speed of the terminal device and the wavelength of the downlink channel carrier, such that adaptive computation and adjustment of the Doppler spread may be implemented according to the moving speed of the terminal device, and a mobile communication effect can be effectively guaranteed. As the Doppler spread may be configured to determine the time difference for computing the Doppler shifts, accuracy of the computed Doppler shifts can be ensured.

In the example of the disclosure, when the Doppler spread of the terminal device is determined, the moving speed v of the terminal device may be determined, and the wavelength λ of the downlink channel carrier may be determined. Then, the computation formula

$${D}_{s} = \frac{V}{λ}$$

of the Doppler spread Ds may be introduced, and the Doppler spread Ds may be determined according to the moving speed and the wavelength of the downlink channel carrier.

In some other examples, the time difference may also be determined according to the tracking reference signal (TRS). The time difference may be set as N times of an interval between a first time slot and a second time slot of transmitting the tracking reference signal (TRS) in one period. N is a positive integer. Alternatively, M times of a difference between different orthogonal frequency division multiplexing (OFDM) symbols in one time slot may be determined as the time difference. M is a positive integer. Values of N and M may be a value negotiated by the network device and the terminal device, or may be configured to the terminal device by the network device, or may be reported to the network device by the terminal device.

In some other examples, a time difference may also be predefined by the network device and the terminal device, and the time difference

$$Δ t = \frac{1}{f}$$

may be set, where f represents an interval of subcarriers. The predefined time difference is obtained, such that the time difference may be obtained.

S504: the time difference is transmitted to the network device.

In the example of the disclosure, when the time difference is determined by the terminal device, the time difference determined by the terminal device may be transmitted to the network device. For example, when the time difference is determined by the terminal device according to the Doppler spread, the time difference may be transmitted to the network device by the terminal device. Alternatively, when the time difference is determined by the terminal device according to the received tracking reference signal, the time difference may be transmitted to the network device, and the time difference preset by the terminal device may also be transmitted to the network device.

In the example of the disclosure, after the time difference is obtained, the time difference may be transmitted to the network device, such that the Doppler shift may be determined by the network device.

S505: the phase differences of the transmission paths are determined according to the time difference and the Doppler shift.

In the example of the disclosure, after the time difference is obtained and the Doppler shift of the transmission path is determined according to the tracking reference signal, the phase difference of the transmission path may be determined according to the time difference and the Doppler shift.

In the example of the disclosure, when the Doppler shift of the transmission path is determined according to the tracking reference signal, the computation formula

$${f}_{d} = \frac{Δφ}{2 πΔ t}$$

of the Doppler shift may be introduced. f_{d} denotes the Doppler shift, Δφ denotes the phase difference (a value range of the phase difference Δφ may be 0-2π), and Δt denotes the time difference. Then, the phase difference Δφ may be computed according to the computation formula of the Doppler shift, the time difference and the Doppler shift, and the determined phase difference may be used as the phase information. The phase information is transmitted to the network device.

S506: the phase differences are transmitted to the network device.

Reference may be made to the description of the above example for detailed introduction of S506, which will not be repeated in the example of the disclosure.

It is to be noted that execution orders of transmitting the time difference and the phase difference to the network device are not limited in the example of the disclosure. For example, the time difference may be transmitted firstly, and then the phase difference may be transmitted. Alternatively, the time difference and the phase difference may be transmitted simultaneously. Alternatively, the phase difference may be transmitted firstly, and then the time difference may be transmitted.

In the example, the time difference is obtained, where the phase difference and the time difference are configured to enable the network device to determine the Doppler shift, the time difference is transmitted to the network device, the phase difference of the transmission path is determined according to the time difference and the Doppler shift, and the phase difference is transmitted to the network device, such that the phase difference of the transmission path may be determined according to the time difference and the Doppler shift. As the time difference may be obtained through negotiation between the network device and the terminal device, it may be ensured that the time difference may satisfy a communication transmission requirement, such that accuracy of the phase difference generated according to the time difference can be ensured, and communication performance of the communication system can be guaranteed.

FIG. 6 is a schematic flow diagram of yet another method for transmitting information according to an example of the disclosure. The method for transmitting information in the example is performed by a terminal device. As shown in FIG. 6, the method may include, but is not limited to, the following steps:

S601: a tracking reference signal is received.

S602: Doppler shifts of transmission paths are determined according to the tracking reference signal.

Reference may be made to the description of the above example for detailed introduction of S601 and S602, which will not be repeated in the example of the disclosure.

S603: phase deflection values of the transmission paths are determined according to the Doppler shifts, where the phase deflection values are used as phase information.

A plurality of transmission paths are provided. Each of the transmission paths corresponds to one of the phase deflection values. When the phase information is transmitted to the network device, the phase deflection values corresponding to the plurality of transmission paths may be transmitted to the network device.

S604: the phase deflection values corresponding to the plurality of transmission paths are transmitted to the network device.

In the example of the disclosure, after the phase deflection values of the transmission paths are determined according to the Doppler shifts, the plurality of phase deflection values may be transmitted to the network device.

In the example of the disclosure, when the plurality of phase deflection values are transmitted to the network device, each phase deflection value may be quantified. After quantification, an indication message corresponding to each phase deflection value is generated, and channel status information (CSI) is transmitted to the network device by the terminal device, such that the indication message corresponding to each phase deflection value is carried by the channel status information (CSI), and the plurality of phase deflection values are transmitted to the network device.

An example of the disclosure provides a method for transmitting information. The plurality of phase deflection values are transmitted to the network device as follows: each of the phase deflection values is processed, each corresponding first target processing value is obtained, each of the phase deflection values is processed, each corresponding second target processing value is obtained, each of the first target processing values is quantified based on a second bit number, each corresponding third quantified result value is obtained, each of the second target processing values is quantified based on a third bit number, each corresponding fourth quantified result value is obtained, third indication messages are generated according to the third quantified result values and the corresponding fourth quantified result values, and a plurality of third indication messages are transmitted to the network device. The plurality of phase deflection values may be quantified for indication based on different numbers of bits, and transmitted to the network device through the indication message, such that indication overhead of transmitting the plurality of phase deflection values to the network device can be greatly reduced. After the indication message is received by the network device, the Doppler shifts of the transmission paths may be conveniently restored by the network device based on the plurality of phase deflection values, and accuracy of channel information estimation can be guaranteed.

The first target processing values and the second target processing values are values obtained by processing the phase deflection values. Processing methods for the first target processing values and the second target processing values are different.

The second bit number and the third bit number are numbers of bits occupied for quantifying the phase deflection values, and may be represented by L1 and L2, respectively. For example, if L1=3 bits and L2=4 bits, values of L1 and L2 may be determined by the network device through signaling configuration or reported to the network device by the terminal device.

The third quantified result value is a result value obtained by quantifying the first target processing value based on the second bit number.

The fourth quantified result value is a result value obtained by quantifying the second target processing value based on the third bit number.

The third indication message is an indication message generated according to the third quantified result value and the corresponding fourth quantified result value. The plurality of third indication messages may be transmitted to the network device, so as to indicate the plurality of corresponding phase deflection values.

In the example of the disclosure, when the phase deflection values corresponding to the plurality of transmission paths are transmitted to the network device, each phase deflection value φ may be processed, the plurality of corresponding first target processing values

$$⌊ \frac{φ}{2 π} ⌋$$

may be obtained, each phase deflection value may be processed, and the plurality of corresponding second target processing values

$$φ - 2 π ⌊ \frac{φ}{2 π} ⌋$$

may be obtained. That is, each phase deflection value φ may be processed into two parts

$$⌊ \frac{φ}{2 π} ⌋ and φ - 2 π ⌊ \frac{φ}{2 π} ⌋ ,$$

which is not limited here.

In the example of the disclosure, each phase deflection value is processed to obtain the corresponding first target processing value, and each phase deflection value is processed to obtain the corresponding second target processing value. Then, each first target processing value may be quantified based on the second bit number L1, and each corresponding third quantified result value may be obtained. Each second target processing value may be quantified based on the third bit number L2 (the values of L1 and L2 may be determined by the network device through signaling configuration, or be reported to the network device by the terminal device), and each corresponding fourth quantified result value may be obtained. In addition, the third indication messages may be generated according to the third quantified result values and the corresponding fourth quantified result values. The third indication messages are carried in channel status information (CSI), and the channel status information (CSI) is transmitted to the network device, such that the third indication messages may be carried by the channel status information (CSI) and transmitted to the network device, and the plurality of phase deflection values may be transmitted to the network device.

S605: a reference offset direction is determined according to the Doppler shifts.

The reference offset direction is configured to indicate offset direction information when the Doppler shifts occur.

In the example of the disclosure, the reference offset direction is determined according to the Doppler shifts, the reference offset direction is quantified to generate a corresponding indication message, and the indication message is transmitted to the network device, such that the reference offset direction may be obtained by the network device.

S606: the reference offset direction is quantified based on a fourth bit number, and a fifth quantified result value is obtained.

The fourth bit number is a number of bits required for quantifying the reference offset direction. The fourth bit number may be 1.

The fifth quantified result value is a result value obtained by quantifying the reference offset direction based on the fourth bit number.

In the example of the disclosure, if 1 bit is added to indicate the reference offset direction, the fourth bit number may be 1. Then, the reference offset direction corresponding to each of the transmission paths may be quantified based on the fourth bit number, and the result value obtained through quantification may be used as the fifth quantified result value corresponding to the transmission path.

S607: a fourth indication message is generated according to the fifth quantified result value.

The fourth indication message is an indication message generated according to the fifth quantified result value. The fourth indication message may be configured to indicate the reference offset direction.

In the example of the disclosure, a corresponding indication message may be generated according to a fifth quantified result, and the generated indication message may be used as the fourth indication message. The plurality of fifth quantified result values may be generated into one fourth indication message, or a corresponding fourth indication message may be generated according to each fifth quantified result value.

S608: the fourth indication message is transmitted to the network device.

In the example of the disclosure, when the fourth indication message is transmitted to the network device, the fourth indication message may be carried by the channel status information (CSI), and the channel status information (CSI) may be transmitted to the network device. The fourth indication message may be carried by the channel status information (CSI) and transmitted to the network device.

It is to be noted that execution orders of transmitting the phase deflection values to the network device and transmitting the fourth indication message (the fourth indication message is configured to indicate the reference offset direction) to the network device are not limited in the example of the disclosure.

In the example, the phase deflection values of the transmission paths are determined according to the Doppler shifts, where the phase deflection values are used as the phase information, and the plurality of phase deflection values are transmitted to the network device. As the phase deflection values are processed and quantified for indication and then are transmitted to the network device, feedback indication overhead can be greatly reduced. When the plurality of phase shift values are transmitted to the network device separately, the Doppler shifts of the transmission paths may be conveniently restored by the network device based on the plurality of phase shift values, such that accuracy of channel information estimation can be guaranteed. The reference offset direction is determined according to the Doppler shifts, the reference offset direction is quantified based on the fourth bit number, the fifth quantified result value is obtained, the fourth indication message is generated according to the fifth quantified result value, and the fourth indication message is transmitted to the network device. The reference offset direction is quantified for indication and transmitted to the network device, and the indication message is parsed by the network device, such that the reference offset direction may be obtained. As the reference offset direction may participate in restoring the Doppler shifts, accuracy of the Doppler shifts restored by the network device can be ensured. When the channel information is predicted by the network device based on the determined Doppler information, accuracy of the predicted channel information can be ensured.

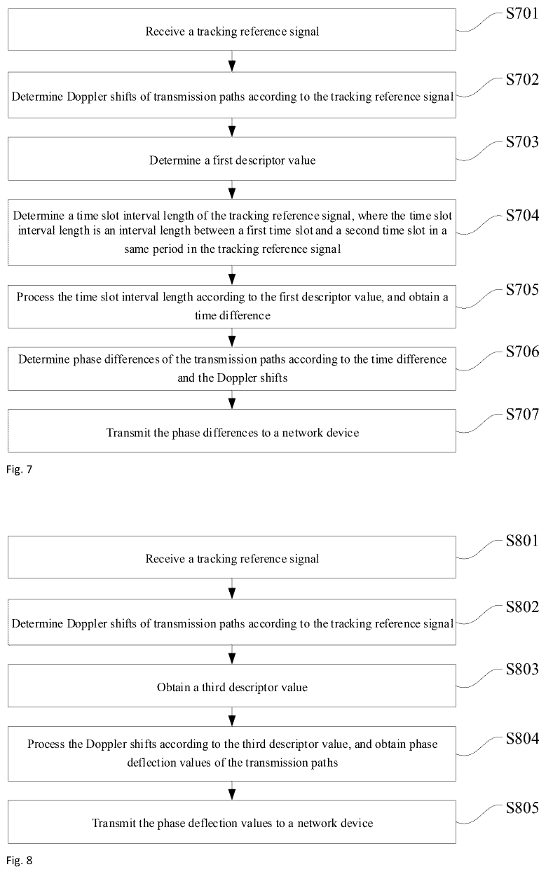

FIG. 7 is a schematic flow diagram of yet another method for transmitting information according to an example of the disclosure. The method for transmitting information in the example is performed by a terminal device. As shown in FIG. 7, the method may include, but is not limited to, the following steps:

S701: a tracking reference signal is received.

S702: Doppler shifts of transmission paths are determined according to the tracking reference signal.

Reference may be made to the description of the above example for detailed introduction of S701 and S702, which will not be repeated in the example of the disclosure.

S703: a first descriptor value is determined.

The first descriptor value is a parameter value configured for data processing. The first descriptor value may be set as a positive integer.

In the example of the disclosure, when the first descriptor value is determined, the first descriptor value may be preset through negotiation between the terminal device and the network device, or may be configured for the terminal device by the network device, or may be configured for the network device by the terminal device.

S704: a time slot interval length of the tracking reference signal is determined, where the time slot interval length is an interval length between a first time slot and a second time slot in a same period in the tracking reference signal.

The time slot interval length is the interval length between the first time slot and the second time slot in the same period in the tracking reference signal.

In the example of the disclosure, when the time difference is obtained, the first descriptor value may be determined, the interval length between the first time slot and the second time slot in the same period in the tracking reference signal (TRS) may be determined, the interval length between the first time slot and the second time slot in the same period in the tracking reference signal (TRS) may be used as the time slot interval length, and then the time difference may be determined according to the first descriptor value and the time slot interval length.

S705: the time slot interval length is processed according to the first descriptor value, and the time difference is obtained.

In the example of the disclosure, when the time slot interval length is processed according to the first descriptor value and the time difference is obtained, the time slot interval length may be multiplied by the first descriptor value, and the processed interval length may be used as the time difference.

An example of the disclosure provides a method for transmitting information. The time difference is determined according to the tracking reference signal as follows: a second descriptor value is determined, a symbol difference between different orthogonal frequency division multiplexing symbols in the tracking reference signal is determined, and the symbol difference is described according to the second descriptor value, such that the time difference may be obtained. In this way, the symbol difference between the orthogonal frequency division multiplexing symbols may be described to determine the time difference, and the time difference may be determined in a more flexible manner. Accurate obtainment in different communication scenes is ensured, such that the method for transmitting information can adapt to various communication scenes, and applicability of the method for transmitting information can be improved.

The second descriptor value is a parameter value configured for data processing. The second descriptor value may be set as a positive integer.

In the example of the disclosure, when the second descriptor value is determined, the second descriptor value may be preset through negotiation between the terminal device and the network device, or may be configured for the terminal device by the network device, or may be configured for the network device by the terminal device. Then, the symbol difference between different orthogonal frequency division multiplexing (OFDM) symbols in the tracking reference signal (TRS) may be determined, and then the symbol difference may be described according to the second descriptor value. The second descriptor value may be multiplied by the symbol difference, and a processing result may be used as the time difference.

S706: the phase differences of the transmission paths are determined according to the time difference and the Doppler shifts.

S707: the phase differences are transmitted to the network device.

Reference may be made to the description of the above example for detailed introduction of S706 and S707, which will not be repeated in the example of the disclosure.

In the example, the first descriptor value is determined, the time slot interval length of the tracking reference signal is determined, where the time slot interval length is the interval length between the first time slot and the second time slot in the same period in the tracking reference signal, and the time slot interval length is processed according to the first descriptor value, such that the time difference is obtained. The time difference may be determined according to the time slot interval length of the tracking reference signal. As more accurate time-frequency tracking may be implemented with the tracking reference signal, accuracy of the obtained time difference can be ensured. When the phase differences of the transmission paths are determined according to the time difference and the Doppler shifts, accuracy of the computed phase differences can be ensured. When the Doppler shifts are restored by the network device according to the phase differences transmitted by the terminal device, a restoration effect of the Doppler shifts can effectively be ensured.

FIG. 8 is a schematic flow diagram of yet another method for transmitting information according to an example of the disclosure. The method for transmitting information in the example is applicable to a terminal device. As shown in FIG. 8, the method may include, but is not limited to, the following steps:

S801: a tracking reference signal is received.

S802: Doppler shifts of transmission paths are determined according to the tracking reference signal.

Reference may be made to the description of the above example for detailed introduction of S801 and S802, which will not be repeated in the example of the disclosure.

S803: a third descriptor value is obtained.

The third descriptor value is a parameter value configured to process the Doppler shifts. The third descriptor value may be set as 2π.

In the example of the disclosure, when the third descriptor value is obtained, the 2π may be set as the third descriptor value, the Doppler shifts may be processed according to the third descriptor value, and the phase deflection values of the transmission paths may be obtained.

S804: the Doppler shifts are processed according to the third descriptor value, and the phase deflection values of the transmission paths are obtained.

In the example of the disclosure, after the Doppler shifts of the transmission paths are determined according to the tracking reference signal and the third descriptor value is obtained, the Doppler shifts may be processed according to the third descriptor value, and the phase deflection values of the transmission paths may be obtained.

In the example of the disclosure, when the Doppler shifts are processed according to the third descriptor value and the phase deflection values of the transmission paths are obtained, the third descriptor value may be multiplied by the Doppler shifts, and the phase deflection values of the transmission paths may be obtained.

For example, according to the received tracking reference signal (TRS), Doppler shifts f_{d,i} corresponding to main K=4 transmission paths may be screened by the terminal device (user equipment (UE)) as 20 Hz, 40 Hz, 60 Hz and 80 Hz through a power delay profile (PDP), where i=1, 2, 3, 4. Accordingly, the third descriptor value is set as 2π, the Doppler shifts f_{d,i} are processed according to the third descriptor value 2π, 40π, 80π, 120π and 160π are computed as the phase shift values corresponding to all the transmission paths according to 2πf_{d,i}, and L1=8 bits and L2=4 bits are configured for the terminal device by the network device separately. The phase deflection value corresponding to each transmission path is indicated by the terminal device through 8 bits and 4 bits respectively.

S805: the phase deflection values are transmitted to the network device.

In the example of the disclosure, after the Doppler shifts are processed according to the third descriptor value and the phase deflection values of the transmission paths are obtained, the phase deflection values of the transmission paths may be used as phase information of the transmission paths. Then, the phase deflection values are transmitted to the network device, such that the phase information may be transmitted to the network device.

In the example, the third descriptor value is obtained, the Doppler shifts are processed according to the third descriptor value, and the phase deflection values of the transmission paths are obtained. The Doppler shifts of the transmission paths may be described correspondingly, and the phase deflection values may be obtained. When the phase deflection values are quantified for indication and transmitted to the network device, feedback overhead of directly reporting the Doppler shifts can be greatly reduced, and information transmission efficiency can be effectively improved.

FIG. 9 is a schematic flow diagram of still another method for transmitting information according to an example of the disclosure. The method for transmitting information in the example is performed by a network device. As shown in FIG. 9, the method may include, but is not limited to, the following steps:

S901: a tracking reference signal is transmitted to a terminal device.

In the example of the disclosure, the tracking reference signal is transmitted to the terminal device by the network device, such that the phase information of the transmission path may be determined by the terminal device according to the tracking reference signal.

In the example of the disclosure, when the tracking reference signal is transmitted to the terminal device, the tracking reference signal may be configured by the network device for a terminal, and the tracking reference signal may be transmitted to the terminal device. The tracking reference signal configured and transmitted by the network device is received by the terminal device. Then, the phase information of the transmission path may be determined by the terminal device according to the tracking reference signal.

S902: phase information of transmission path transmitted by the terminal device is received.

In the example of the disclosure, when the phase information of the transmission path transmitted by the terminal device is received, the phase information of the transmission path may be determined by the terminal device according to the received tracking reference signal, the determined phase information may be reported to the network device by the terminal device, and the phase information of the transmission path transmitted by the terminal device may be received by the network device.

S903: channel information is determined according to the phase information.

The channel information is information for describing a communication status of a channel. The channel information may be, for example, coherence time information of the channel (coherence time is configured to indicate a maximum time difference range in which the channel remains constant), or fading status information configured to describe signal transmission on the channel. The channel information may be determined by the network device based on the phase information reported by the terminal device.

In the example of the disclosure, the phase information may include a phase difference or a phase shift value of the transmission path. When the channel information is determined according to the phase information, the channel information may be determined according to the phase difference of the transmission path or the phase shift value of the transmission path, which are not limited here.

In the example, the tracking reference signal is transmitted to the terminal device, the phase information of the transmission path transmitted by the terminal device is received, where the phase information of the transmission path is determined by the terminal device based on the tracking reference signal, and the channel information is determined according to the phase information, such that the channel information may be determined by the network device based on the received phase information uploaded by the terminal device. As data conversion and quantified for indication are not required for the Doppler shift of the transmission path, through reception of the network device, feedback indication overhead can be effectively reduced, and information transmission efficiency can be improved.

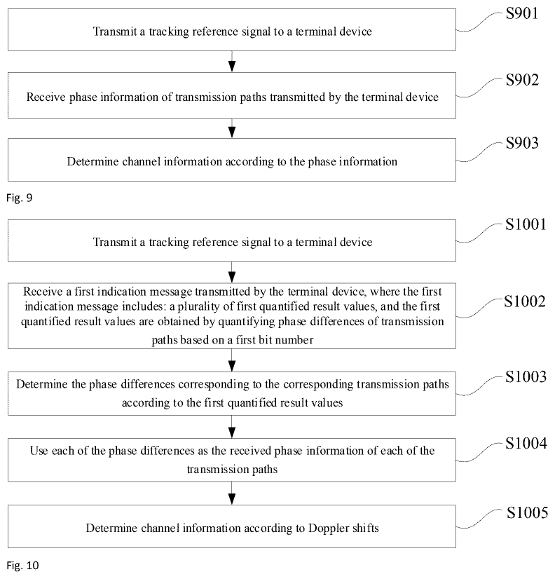

FIG. 10 is a schematic flow diagram of still another method for transmitting information according to an example of the disclosure. The method for transmitting information in the example is performed by a network device. As shown in FIG. 10, the method may include, but is not limited to, the following steps:

S1001: a tracking reference signal is transmitted to a terminal device.

Reference may be made to the description of the above example for detailed introduction of S1001, which will not be repeated in the example of the disclosure.

S1002: a first indication message transmitted by the terminal device is received, where the first indication message includes: a plurality of first quantified result values, and the first quantified result values are obtained by quantifying phase differences of the transmission paths based on a first bit number.

In the example of the disclosure, when the first indication message transmitted by the terminal device is received, the phase differences of the transmission paths may be quantified by the terminal device based on the first bit number, such that the first quantified result values may be obtained, and the first indication message may be generated according to the first quantified result values. Then, the first indication message may be reported by the terminal device, and the first indication message reported by the terminal device may be received by the network device.

S1003: the phase differences corresponding to the corresponding transmission paths are determined according to the first quantified result values.

In the example of the disclosure, after the first indication message transmitted by the terminal device is received, the plurality of phase differences corresponding to the plurality of transmission paths may be determined according to the plurality of first quantified result values respectively.

In the example of the disclosure, when the plurality of phase differences corresponding to the plurality of transmission paths are determined according to the plurality of first quantified result values respectively, each of the first quantified result values may be parsed, and each of the phase differences corresponding to the first quantified result values may be obtained, such that the phase difference corresponding to each of the transmission paths may be determined.

S1004: each of the phase differences is used as the received phase information of each of the transmission paths.

In the example of the disclosure, after the phase difference corresponding to each of the transmission paths is determined according to the plurality of first quantified result values, each phase difference may be used as the received phase information of each of the transmission paths. The phase information may be configured to determine the channel information.

In the example of the disclosure, when Doppler shifts of the transmission paths are determined according to the phase information, a computation formula of the Doppler shifts may be introduced, and the Doppler shifts of the transmission paths may be computed according to the computation formula of the Doppler shifts and the phase differences of the transmission paths in the phase information, such that the Doppler shifts of the transmission paths may be determined according to the phase information.

An example of the disclosure provides a method for transmitting information. The method further includes the following steps: a fourth indication message transmitted by the terminal device is received, where the fourth indication message includes: a fifth quantified result value, the fifth quantified result value is obtained by quantifying a reference offset direction based on a fourth bit number, and the reference offset direction is determined based on the Doppler shifts; the reference offset direction is determined according to the fifth quantified result value; and target processing is conducted on the reference offset direction. The reference offset direction may be obtained by parsing the indication message corresponding to the reference offset direction reported by the terminal device. As the reference offset direction may participate in restoring the Doppler shifts, accuracy of the Doppler shifts restored by the network device can be ensured. When the channel information is predicted by the network device based on the determined Doppler information, accuracy of the predicted channel information can be ensured.

In the example of the disclosure, the fourth indication message may also be reported by the terminal device, and the fourth indication message reported by the terminal device may be received by the network device. The fourth indication message includes the fifth quantified result value. The fifth quantified result value is obtained by quantifying the reference offset direction based on the fourth bit number. The reference offset direction is determined by the terminal device based on the Doppler shifts.

In the example of the disclosure, after the fourth indication message transmitted by the terminal device is received by the network device, the fifth quantified result value included in the fourth indication message may be parsed, and the reference offset direction may be obtained. Then, the reference offset direction may be subjected to target processing, and reference offset direction may be used as the phase information so as to participate in determining the channel information.

S1005: the channel information is determined according to the Doppler shifts.

In the example of the disclosure, after the Doppler shifts of the transmission paths are determined according to the phase information, the channel information may be determined according to the Doppler shifts.

In the example of the disclosure, when the channel information is determined according to the Doppler shifts, a time domain correlation coefficient may be computed according to the Doppler shifts. Then, uplink channel information in the future may be computed as the channel information according to the computed time domain correlation coefficient.

For example, assuming that a speed of the terminal device and a carrier frequency f_{c} of a downlink channel may be estimated to be 30 Km/h and 3.5 GHz respectively by the network device according to a distance change transmitted by the terminal device in time t, the Doppler spread of the terminal satisfies

$${D}_{s} = \frac{v}{λ} = \frac{{vf}_{c}}{c} \approx 100 hz ,$$

where c=3.0×10⁸ m/s, and c represents a speed of light. Doppler shifts f_{d,i} corresponding to main K=4 transmission paths may be screened by the terminal device as 20 Hz, 40 Hz, 60 Hz and 80 Hz through a power delay profile (PDP) according to the received tracking reference signal (TRS), where i=1, 2, 3, 4, and a corresponding amplitude of each path is defined as aᵢ. If

$$Δ t = \frac{1}{{D}_{s}} = 0.01 s ,$$

phase differences corresponding to 4 transmission paths may be computed as

$$\frac{2 π}{5} , \frac{4 π}{5} , \frac{6 π}{5} \frac{8 π}{5}$$

through a formula Δφᵢ=2πΔtf_{d,i}, and each phase difference is quantified through L=4 bits and then reported to the network device by the terminal device. A total of 16 bits is required to indicate the phase differences corresponding to the 4 transmission paths. If an amplitude of aᵢ is arranged in an ascending order as a₁<a₄<a₃<a₂, phase difference arrangement positions of the 4 transmission paths are transmission path 1, transmission path 4, transmission path 3 and transmission path 2 sequentially.

After the phase differences corresponding to all the transmission paths are received by the network device, the Doppler shift of each of the transmission paths may be computed according to the phase differences corresponding to all the transmission paths through

$${f}_{d} = \frac{Δφ}{2 π Δ t} .$$

According to a sounding reference signal (SRS) transmitted by an uplink terminal device, uplink frequency domain channel information H at moment to may be estimated by the network device, and the corresponding time domain channel information may be obtained by conducting inverse discrete Fourier transform (DFT) on H. That is, h=f_{IDFT}(H)=Σᵢ₌₁¹bᵢδ(t₀−τᵢ), where τᵢ represents a time delay of an ith transmission path. Uplink and downlink channels have different gains because of phase deflection caused by small-scale fading, and the uplink and downlink channels have a basically consistent amplitude of channel gains. That is, abs(bᵢ)≈abs(aᵢ), where abs(a) represents an amplitude of a plural a. The time domain correlation coefficient R is computed by the network device through the following formula

$$R = {\sum }_{i = 1}^{4} {e}^{i 2 π {f}_{d , i} {nd}_{s}} ,$$

where n represents an OFDM symbol distance between the moments t and to, and dₛ represents duration occupied by an orthogonal frequency division multiplexing (OFDM) symbol. The uplink channel information at the moment t is computed as the channel information by the network device according to the correlation coefficient and the estimated channel at the moment to.

In the example, the first indication message transmitted by the terminal device is received, where the first indication message includes: the plurality of first quantified result values, and the first quantified result values are obtained by quantifying the phase differences of the transmission paths based on the first bit number. The plurality of phase differences corresponding to the plurality of transmission paths are determined according to the plurality of first quantified result values respectively, and the plurality of phase differences are used as the received phase information of the plurality of transmission paths respectively, such that the plurality of phase differences may be received as the phase information. As the phase differences are quantified by the terminal device and the indication message is generated and transmitted to the network device, communication information transmission overhead can be effectively reduced, and the phase differences can be correctly indicated to the network device. After the first indication message is received by the network device, the first indication message may be parsed, and the phase differences corresponding to the plurality of transmission paths may be obtained for restoring the Doppler shifts, such that accuracy of the Doppler shifts restored by the network device can be ensured. The Doppler shifts of the transmission paths are determined according to the phase information, and the channel information is determined according to the Doppler shifts. As the Doppler shifts of the transmission paths are directly determined according to the phase information of the transmission paths, efficiency of determining the Doppler shifts of the transmission paths can be effectively improved. As the channel information may be determined according to the Doppler shifts, efficiency of determining the channel information can be effectively improved.

FIG. 11 is a schematic flow diagram of still another method for transmitting information according to an example of the disclosure. The method for transmitting information in the example is performed by a network device. As shown in FIG. 11, the method may include, but is not limited to, the following steps:

S1101: a tracking reference signal is transmitted to a terminal device.

Reference may be made to the description of the above example for detailed introduction of S1101, which will not be repeated in the example of the disclosure.

S1102: a second indication message transmitted by the terminal device is received, where the second indication message includes: a second quantified result value, the second quantified result value is obtained by quantifying a target phase difference based on a first bit number, and the target phase difference is determined from the plurality of phase differences.

In the example of the disclosure, when the second indication message transmitted by the terminal device is received, the phase differences of the transmission paths may be quantified by the terminal device based on the first bit number, such that the second quantified result values may be obtained, and the second indication message may be generated according to the second quantified result values. Then, the second indication message may be reported by the terminal device, and the second indication message reported by the terminal device may be received by the network device.

S1103: the target phase difference is determined according to the second quantified result value.

In the example of the disclosure, after the second indication message transmitted by the terminal device is received, the target phase difference corresponding to the plurality of transmission paths may be determined according to the second quantified result value.

In the example of the disclosure, when the target phase difference is determined according to the second quantified result value, the second quantified result value may be parsed, and the target phase difference corresponding to the second quantified result value may be obtained, such that the target phase difference may be determined according to the second quantified result value.

S1104: the target phase difference is used as the received phase information of the transmission paths.

In the example of the disclosure, after the target phase difference is determined according to the second quantified result value, the target phase difference may be used as the received phase information of the transmission paths. The phase information may be configured to determine the channel information.

An example of the disclosure provides a method for transmitting information. A plurality of transmission paths are provided, and the plurality of transmission paths correspond to a plurality of phase deflection values. The phase information of the transmission paths transmitted by the terminal device is received as follows: a plurality of third indication messages transmitted by the terminal device are received, where the third indication messages include: third quantified result values and fourth quantified result values, the third quantified result values are obtained by quantifying first target processing values based on a second bit number, and the fourth quantified result values are obtained by quantifying second target processing values based on a third bit number; the first target processing values are determined according to the third quantified result values; the second target processing values are determined according to the fourth quantified result values; the corresponding phase deflection values are determined according to the first target processing values and the second target processing values; and each of the phase deflection values is used as the received phase information of each of the transmission paths. As the plurality of phase deflection values are quantified for indication based on different numbers of bits and transmitted to the network device through the indication message, indication overhead of transmitting the plurality of phase shift values to the network device separately can be greatly reduced. After the indication message is received by the network device, the Doppler shifts of the transmission paths may conveniently restored by the network device based on the plurality of phase shift values, such that accuracy of channel information estimation can be guaranteed.

In the example of the disclosure, when the phase information of the transmission paths transmitted by the terminal device is received, the plurality of third indication messages may be uploaded by the terminal device, and the plurality of third indication messages transmitted by the terminal device may be received by the network device. The third indication messages include: the third quantified result values and the fourth quantified result values. The third quantified result values are obtained by quantifying the first target processing values based on the second bit number. The fourth quantified result values are obtained by quantifying the second target processing values based on the third bit number.

In the example of the disclosure, after the phase information of the transmission paths transmitted by the terminal device is received, the first target processing values may be determined according to the third quantified result values, and the third quantified result values may be parsed, such that the first target processing values may be determined. The second target processing values may be determined according to the fourth quantified result values, and the fourth quantified result values may be parsed, such that the second target processing values may be determined. Then, the corresponding phase deflection values may be determined according to the first target processing values and the second target processing values, and the plurality of phase deflection values may be used as the received phase information of the transmission paths.

S1105: channel information is determined according to the phase information.

Reference may be made to the description of the above example for detailed introduction of S1105, which will not be repeated in the example of the disclosure.

In the example, the second indication message transmitted by the terminal device is received, where the second indication message includes: the second quantified result value, the second quantified result value is obtained by quantifying the target phase difference based on the first bit number, and the target phase difference is determined from the plurality of phase differences. The target phase difference is determined according to the second quantified result value. The target phase difference is used as the received phase information of the transmission paths. The received indication message may be parsed, and the target phase difference may be restored according to the second quantified result value in the second indication message. Thus, it may be ensured that the target phase difference may be accurately transmitted to the network device such that the corresponding target phase difference may be obtained as the phase information. As the indication message is carried in channel status information so as to be transmitted, a huge amount of communication resources can be prevented from being occupied, and communication efficiency can be guaranteed.

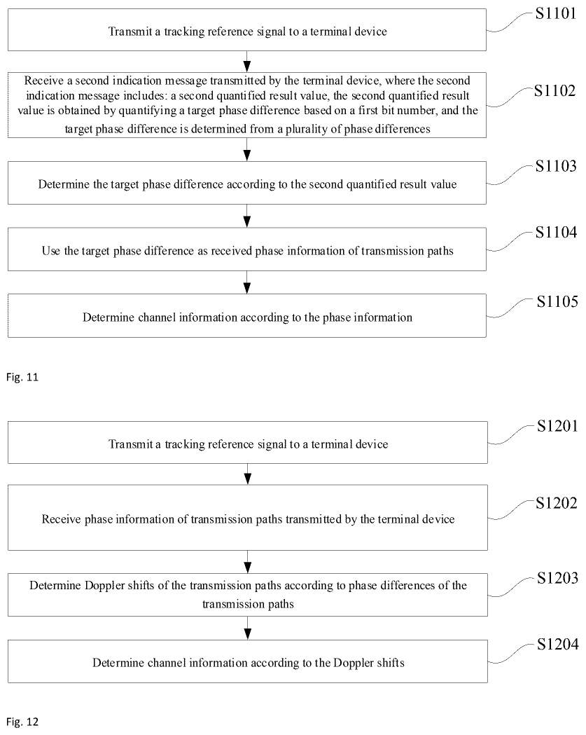

FIG. 12 is a schematic flow diagram of still another method for transmitting information according to an example of the disclosure. The method for transmitting information in the example is performed by a network device. As shown in FIG. 12, the method may include, but is not limited to, the following steps:

S1201: a tracking reference signal is transmitted to a terminal device.

S1202: phase information of transmission paths transmitted by the terminal device is received.

The phase information includes phase differences of the transmission paths, or phase deflection values of the transmission paths.

Reference may be made to the description of the above example for detailed introduction of S1201 and S1202, which will not be repeated in the example of the disclosure.

S1203: Doppler shifts of the transmission paths are determined according to phase differences of the transmission paths.

In the example of the disclosure, when the Doppler shifts of the transmission paths are determined according to the phase differences of the transmission paths, a computation formula of the Doppler shifts may be introduced, and the Doppler shifts of the transmission paths may be determined according to the computation formula of the Doppler shifts and the phase differences of the transmission paths.

S1204: channel information is determined according to the Doppler shifts.

Reference may be made to the description of the above example for detailed introduction of S1204, which will not be repeated in the example of the disclosure.

In the example, the Doppler shifts of the transmission paths are determined according to the phase differences of the transmission paths, and the channel information is determined according to the Doppler shifts. The Doppler shifts of the transmission paths may be restored according to the phase differences of the transmission paths. As the Doppler shifts of the transmission paths are directly determined according to the phase information of the transmission paths, efficiency of determining the Doppler shifts of the transmission paths can be effectively improved. As the channel information may be determined according to the Doppler shifts, efficiency of determining the channel information can be effectively improved.

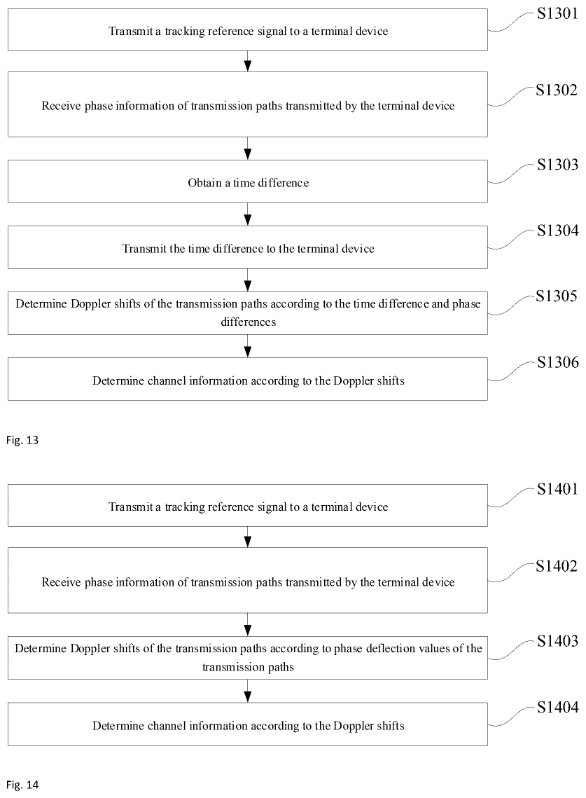

FIG. 13 is a schematic flow diagram of still another method for transmitting information according to an example of the disclosure. The method for transmitting information in the example is performed by a network device. As shown in FIG. 13, the method may include, but is not limited to, the following steps:

S1301: a tracking reference signal is transmitted to a terminal device.

S1302: phase information of transmission paths transmitted by the terminal device is received.

The phase information includes: phase differences of the transmission paths.

Reference may be made to the description of the above example for detailed introduction of S1301 and S1302, which will not be repeated in the example of the disclosure.

S1303: a time difference is obtained.

An example of the disclosure provides a method for transmitting information. The time difference is obtained by any one of the following methods: the time difference transmitted by the terminal device is received, a Doppler spread of the terminal device is determined, the time difference is determined according to the Doppler spread, the time difference is determined according to the tracking reference signal, and the preset time difference is obtained. More modes of obtaining the time difference are set, such that flexibility of obtaining the time difference can be effectively improved, and the mode of determining the time difference can be effectively applied to personalized communication scenes. As both the network device and the terminal device may participate in setting of the time difference, it can be guaranteed that setting of the time difference can satisfy a communication requirement between the terminal device and the network device, and a communication effect can be guaranteed.

The Doppler spread may be Doppler spread information. The Doppler spread Ds may be determined by the terminal device, and then the Doppler spread Ds may be reported to the network device by the terminal device. Alternatively, the Doppler spread Ds may be determined by the network device, and the Doppler spread Ds may be transmitted to the terminal device by a network side through downlink signaling.

In the example of the disclosure, when the time difference is obtained, the time difference Δt may be determined by the terminal device, and the time difference Δt may be transmitted to the network device by the terminal device, such that the time difference may be obtained. The phase differences and the time difference may be configured to enable the network device to determine the Doppler shifts.

In some examples, when the time difference is obtained, the Doppler spread Ds of the terminal device may be determined. The Doppler spread Ds represents the Doppler spread. The Doppler spread Ds may be determined by the terminal device, or the Doppler spread Ds may be determined by the network device. Then, a computation formula of the time difference related to the Doppler spread Ds may be introduced, and the corresponding time difference may be computed according to the computation formula of the time difference and the Doppler spread Ds, such that the time difference may be obtained.

An example of the disclosure provides a method for transmitting information. The Doppler spread of the terminal device is determined as follows: a moving speed of the terminal device is determined, a wavelength of a downlink channel carrier is determined, and the Doppler spread is determined according to the moving speed and the wavelength of the downlink channel carrier. The corresponding Doppler spread is determined according to the moving speed of the terminal and the wavelength of the downlink channel carrier, such that adaptive computation and adjustment of the Doppler spread may be implemented according to the moving speed of the terminal, and a mobile communication effect can be effectively guaranteed. As the Doppler spread may be configured to determine the time difference for computing the Doppler shifts, accuracy of the computed Doppler shifts can be ensured.

In the example of the disclosure, when the Doppler spread of the terminal device is determined, the moving speed F of the terminal device may be determined, and the wavelength λ of the downlink channel carrier may be determined. Then, the computation formula

$${D}_{s} = \frac{v}{λ}$$

of the Doppler spread may be introduced, and the Doppler spread may be determined according to the moving speed and the wavelength of the downlink channel carrier.

In some other examples, the time difference may also be determined according to the tracking reference signal (TRS). The time difference may be set as N times of an interval between a first time slot and a second time slot of transmitting the tracking reference signal (TRS) in one period. N is a positive integer. Alternatively, M times of a difference between different orthogonal frequency division multiplexing (OFDM) symbols in one time slot may be determined as the time difference. M is a positive integer. Values of N and M may be a value negotiated and reserved between the network device and the terminal device, or may be configured to the terminal device by the network device, or may be reported to the network device by the terminal device.

In some other examples, one time difference may also be predefined by the network device and the terminal device, and the time difference

$$Δ t = \frac{1}{f}$$

may be set, where f represents an interval of subcarriers. The predefined time difference is obtained, such that the time difference may be obtained.

S1304: the time difference is transmitted to the terminal device.

In the example of the disclosure, after the time difference is obtained, the time difference may be transmitted to the terminal device. When the time difference is determined by the network device, the time difference may be transmitted to the terminal device.

It is to be noted that in the example of the disclosure, execution orders of transmitting the time difference and the tracking reference signal to the terminal device are not limited in the example of the disclosure.

S1305: the Doppler shifts of the transmission paths are determined according to the time difference and the phase differences.

In the example of the disclosure, after the time difference is obtained, the Doppler shifts of the transmission paths may be determined according to the time difference and the phase differences. A computation formula

$${f}_{d} = \frac{Δφ}{2 π Δ t}$$

of the Doppler shifts may be introduced, and the Doppler shifts of the transmission paths may be computed according to the computation formula of the Doppler shifts, the time difference and the phase differences.

S1306: channel information is determined according to the Doppler shifts.

Reference may be made to the description of the above example for detailed introduction of S1306, which will not be repeated in the example of the disclosure.

In the example, the time difference is obtained, and the Doppler shifts of the transmission paths are determined according to the time difference and the phase differences, such that the Doppler shifts of the transmission paths may be determined according to the time difference and the phase differences. As the time difference may be obtained through negotiation between the network device and the terminal device, it may be ensured that the time difference may satisfy a communication transmission requirement, such that accuracy of the Doppler shifts generated according to the time difference can be ensured, and communication performance of the communication system can be guaranteed.

FIG. 14 is a schematic flow diagram of still another method for transmitting information according to an example of the disclosure. The method for transmitting information in the example is performed by a network device. As shown in FIG. 14, the method may include, but is not limited to, the following steps:

S1401: a tracking reference signal is transmitted to a terminal device.

S1402: phase information of transmission paths transmitted by the terminal device is received.

The phase information includes phase deflection values of the transmission paths.

Reference may be made to the description of the above example for detailed introduction of S1401 and S1402, which will not be repeated in the example of the disclosure.

S1403: Doppler shifts of the transmission paths are determined according to the phase deflection values of the transmission paths.

In the example of the disclosure, when the Doppler shifts of the transmission paths are determined according to the phase deflection values of the transmission paths, a computation formula of the Doppler shifts may be introduced, and the Doppler shifts of the transmission paths may be determined according to the phase deflection values of the transmission paths and the computation formula of the Doppler shifts.

In the example of the disclosure, when the Doppler shifts of the transmission paths are determined according to the phase deflection values of the transmission paths, the computation formula corresponding to the phase deflection values and parameter values related to the computation formula of the phase deflection values may be determined, and the Doppler shifts may be determined according to the computation formula corresponding to the phase deflection values and the parameter values related to the computation formula of the phase deflection values.

An example of the disclosure provides a method for transmitting information. The Doppler shifts of the transmission paths are determined according to the phase deflection values of the transmission paths as follows: a third descriptor value is obtained, the phase deflection values are processed according to the third descriptor value, and the Doppler shifts of the transmission paths are obtained. The Doppler shifts of the transmission paths may be described correspondingly, and the phase deflection values may be obtained. As the phase deflection values are quantified for indication and transmitted to the network device by the terminal device, feedback overhead of directly reporting the Doppler shifts can be greatly reduced, and information transmission efficiency can be effectively improved.

The third descriptor value is a parameter value configured to process the Doppler shifts. The third descriptor value may be set as 2π.

In the example of the disclosure, when the third descriptor value is obtained, the 2π may be set as the third descriptor value, the Doppler shifts may be processed according to the third descriptor value, and the phase deflection values of the transmission paths may be obtained.

In the example of the disclosure, after the third descriptor value is obtained, the phase deflection values may be processed according to the third descriptor value, and the Doppler shifts of the transmission paths may be obtained.

In the example of the disclosure, when the Doppler shifts are processed according to the third descriptor value and the phase deflection values of the transmission paths are obtained, the phase deflection values are processed according to the third descriptor value, and the Doppler shifts of the transmission paths are obtained. A computation formula 2πf_{d,i} related to the phase deflection values may be introduced, where 2π is the third descriptor value, such that the Doppler shifts f_{d,i} may be computed.

S1404: channel information is determined according to the Doppler shifts.

Reference may be made to the description of the above example for detailed introduction of S1404, which will not be repeated in the example of the disclosure.

In the example, the Doppler shifts of the transmission paths are determined according to the phase deflection values of the transmission paths, and the channel information is determined according to the Doppler shifts. The Doppler shifts of the transmission paths may be determined according to the phase deflection values reported by the terminal device. As the phase deflection values are indicated by a transmission device through the indication message, feedback overhead can be effectively reduced, transmission efficiency of the phase deflection values can be improved, and efficiency of determining the Doppler shifts of the transmission paths can be effectively improved.

FIG. 15 is a schematic flow diagram of still another method for transmitting information according to an example of the disclosure. The method for transmitting information in the example is applicable to a network device. As shown in FIG. 15, the method may include, but is not limited to, the following steps:

S1501: a tracking reference signal is transmitted to a terminal device.

S1502: phase information of transmission paths transmitted by the terminal device is received.

Reference may be made to the description of the above example for detailed introduction of S1501 and S1502, which will not be repeated in the example of the disclosure.

S1503: a first descriptor value is determined.

The first descriptor value is a parameter value configured for data processing. The first descriptor value may be set as a positive integer.

In the example of the disclosure, when the first descriptor value is determined, the first descriptor value may be preset through negotiation between the terminal device and the network device, or may be configured for the terminal device by the network device, or may be configured for the network device by the terminal device.

S1504: a time slot interval length of the tracking reference signal is determined, where the time slot interval length is an interval length between a first time slot and a second time slot in a same period in the tracking reference signal.

The time slot interval length is the interval length between the first time slot and the second time slot in the same period in the tracking reference signal.

In the example of the disclosure, when the time difference is obtained, the first descriptor value may be determined, the interval length between the first time slot and the second time slot in the same period in the tracking reference signal (TRS) may be determined, the interval length between the first time slot and the second time slot in the same period in the tracking reference signal (TRS) may be used as the time slot interval length, and then the time difference may be determined according to the first descriptor value and the time slot interval length.

S1505: the time slot interval length is processed according to the first descriptor value, and the time difference is obtained.

In the example of the disclosure, when the time slot interval length is processed according to the first descriptor value and the time difference is obtained, the time slot interval length may be multiplied by the first descriptor value, and the processed interval length may be used as the time difference.

An example of the disclosure provides a method for transmitting information. The time difference is determined according to the tracking reference signal as follows: a second descriptor value is determined, a symbol difference between different orthogonal frequency division multiplexing symbols in the tracking reference signal is determined, and the symbol difference is described according to the second descriptor value, such that the time difference may be obtained. In this way, the symbol difference between the orthogonal frequency division multiplexing symbols may be described to determine the time difference, and the time difference may be determined in a more flexible manner. Accurate obtainment in different communication scenes is ensured, such that the method for transmitting information can adapt to various communication scenes, and applicability of the method for transmitting information can be improved.

The second descriptor value is a parameter value configured for data processing. The second descriptor value may be set as a positive integer.

In the example of the disclosure, when the second descriptor value is determined, the second descriptor value may be preset through negotiation between the terminal device and the network device, or may be configured for the terminal device by the network device, or may be configured for the network device by the terminal device. Then, the symbol difference between different orthogonal frequency division multiplexing (OFDM) symbols in the tracking reference signal (TRS) may be determined, and then the symbol difference may be described according to the second descriptor value. The second descriptor value may be multiplied by the symbol difference, and a processing result may be used as the time difference.

S1506: the Doppler shifts of the transmission paths are determined according to the time difference and the phase differences.

S1507: channel information is determined according to the Doppler shifts.

Reference may be made to the description of the above example for detailed introduction of S1506 and S1507, which will not be repeated in the example of the disclosure.

In the example, the first descriptor value is determined, the time slot interval length of the tracking reference signal is determined, where the time slot interval length is the interval length between the first time slot and the second time slot in the same period in the tracking reference signal, and the time slot interval length is processed according to the first descriptor value, such that the time difference is obtained. The time difference may be determined according to the time slot interval length of the tracking reference signal. As more accurate time-frequency tracking may be implemented with the tracking reference signal, accuracy of the obtained time difference can be ensured. When the Doppler shifts of the transmission paths are determined according to the time difference and the phase differences, accuracy of the computed Doppler shifts can be ensured. When the Doppler shifts are restored by the network device according to the phase differences transmitted by the terminal device, a restoration effect of the Doppler shifts can effectively be ensured.

An example of the disclosure provides a method for transmitting information. For example, assuming that a speed of the terminal device and a carrier frequency f_{c} of a downlink channel may be estimated to be 30 Km/h and 3.5 GHz respectively by the network device according to a distance change transmitted by the terminal device in time t, the Doppler spread of the terminal device satisfies

$${D}_{s} = \frac{v}{λ} = \frac{{vf}_{c}}{c} \approx 100 hz ,$$

where c=3.0×10⁸ m/s, and c represents a speed of light. Doppler shifts f_{d,i} corresponding to main K=4 transmission paths may be screened by the terminal device as 20 Hz, 40 Hz, 60 Hz and 80 Hz through a power delay profile (PDP) according to the received tracking reference signal (TRS), where i=1, 2, 3, 4, and a corresponding amplitude of each path is defined as aᵢ. If

$$Δ t = \frac{1}{{D}_{s}} = 0.01 s ,$$

phase differences corresponding to 4 transmission paths may be computed as

$$\frac{2 π}{5} , \frac{4 π}{5} , \frac{6 π}{5} and \frac{8 π}{5}$$

through a formula Δφᵢ=2πΔtf_{d,i}, and each phase difference is quantified through L=4 bits and then reported to the network device by the terminal device. A total of 16 bits is required to indicate the phase differences corresponding to the 4 transmission paths. If an amplitude of aᵢ is arranged in an ascending order as a₁<a₄<a₃<a₂, phase difference arrangement positions of the 4 transmission paths are transmission path 1, transmission path 4, transmission path 3 and transmission path 2 sequentially.

After the phase differences corresponding to all the transmission paths are received by the network device, the Doppler shift of each of the transmission paths may be computed according to the phase differences corresponding to all the transmission paths through

$${f}_{d} = \frac{Δφ}{2 π Δ t} .$$

According to a sounding reference signal (SRS) transmitted by an uplink terminal device, uplink frequency domain channel information H at moment to may be estimated by the network device, and the corresponding time domain channel information may be obtained by conducting inverse discrete Fourier transform (DFT) on H. That is, h=f_{IDFT}(H)=Σᵢ₌₁¹bᵢδ(t₀−τᵢ), where τᵢ represents a time delay of an ith transmission path. Uplink and downlink channels have different gains because of phase deflection caused by small-scale fading, and the uplink and downlink channels have a basically consistent amplitude of channel gains. That is, abs(bᵢ)≈abs(aᵢ), where abs(a) represents an amplitude of a plural a.

The time domain correlation coefficient R is computed by the network device through the following formula

$$R = {\sum }_{i = 1}^{4} {e}^{i 2 π {f}_{d , i} {nd}_{s}} ,$$

where n represents an OFDM symbol distance between the moments t and t₀, and dₛ represents duration occupied by an orthogonal frequency division multiplexing (OFDM) symbol. The uplink channel information at the moment t is computed as the channel information by the network device according to the correlation coefficient and the estimated channel at the moment t₀.

An example of the disclosure provides a method for transmitting information. For example, assuming that the conditions are similar to those of Example 1, the Doppler shifts f_{d,i} corresponding to main K=4 transmission paths may be screened by the terminal device as 20 Hz, 40 Hz, 60 Hz and 80 Hz through a power delay profile (PDP) according to the received tracking reference signal (TRS), where i=1, 2, 3, 4. Accordingly, the phase deflection values 40π, 80π, 120π and 160π may be computed according to 2π f_{d,i}. Then, L1=8 bits and L2=4 bits may be configured for the terminal device by the network device separately. The phase deflection values are quantified through 8 bits and 4 bits by the terminal device respectively, and the indication message is generated to indicate the phase deflection value corresponding to each transmission path.

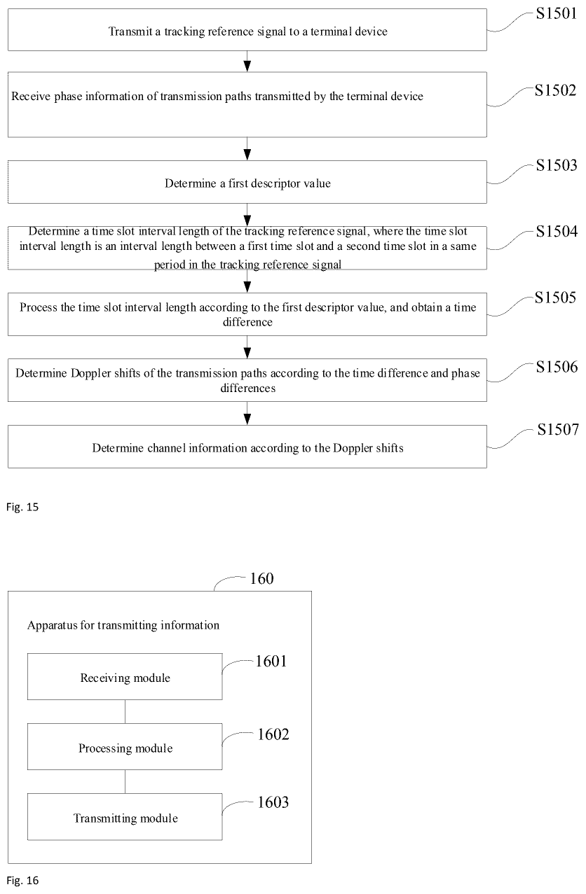

FIG. 16 is a schematic structural diagram of an apparatus for transmitting information according to an example of the disclosure. The apparatus 160 for transmitting information shown in FIG. 16 may include a receiving module 1601, a processing module 1602, and a transmitting module 1603. The transmitting module 1603 is configured to achieve a transmission function. The receiving module 1601 is configured to achieve a reception function.

The apparatus 160 for transmitting information may be a terminal device, or an apparatus in a terminal device, or an apparatus used in cooperation with a terminal device. Alternatively, the apparatus 160 for transmitting information may be a network device, or an apparatus in a network device, or an apparatus used in cooperation with a network device.

The apparatus 160 for transmitting information is located on a terminal device side. The apparatus 160 includes:
a receiving module 1601 configured to receive a tracking reference signal;
a processing module 1602 configured to determine phase information of a transmission path according to the tracking reference signal; and
a transmitting module 1603 configured to transmit the phase information to a network device.

In some examples, a plurality of the transmission paths are provided, and each of the transmission paths corresponds to one of phase differences. The transmitting module 1603 is further configured to:
transmit the phase differences corresponding to a plurality of the transmission paths to the network device separately; and alternatively,
transmit a target phase difference to the network device, where the target phase difference is determined from a plurality of the phase differences.

In some examples, the processing module 1602 is further configured to:
determine, before the target phase difference is transmitted to the network device, a Doppler shift corresponding to each of the transmission paths;
determine a target Doppler shift from a plurality of Doppler shifts; and
determine a phase difference corresponding to the target Doppler shift from the plurality of phase differences, and use the corresponding phase difference as the target phase difference.

In some examples, the processing module 1602 is further configured to:
determine a maximum Doppler shift from a plurality of the Doppler shifts, where the maximum Doppler shift is used as the target Doppler shift; and alternatively,
determine an average Doppler shift from a plurality of the Doppler shifts, where the average Doppler shift is used as the target Doppler shift.

In some examples, the transmitting module 1603 is further configured to:
quantify each of the phase differences based on a first bit number, and obtain a first quantified result value corresponding to each of the phase differences;
generate a first indication message according to a plurality of the first quantified result values; and
transmit the first indication message to the network device.

In some examples, the transmitting module 1603 is further configured to:
quantify the target phase difference based on a first bit number, and obtain a second quantified result value;
generate a second indication message according to the second quantified result value; and
transmit the second indication message to the network device.

In some examples, a plurality of the transmission paths are provided, and each of the transmission paths corresponds to one of phase deflection values. The transmitting module 1603 is further configured to:
transmit the phase deflection values corresponding to a plurality of the transmission paths to the network device.

In some examples, the transmitting module 1603 is further configured to:
process each of the phase deflection values, and obtain each corresponding first target processing value;
process each of the phase deflection values, and obtain each corresponding second target processing value;
quantify each of the first target processing values based on a second bit number, and obtain each corresponding third quantified result value;
quantify each of the second target processing values based on a third bit number, and obtain each corresponding fourth quantified result value;
generate third indication messages according to the third quantified result values and the corresponding fourth quantified result values; and
transmit the plurality of third indication messages to the network device.

In some examples, the transmitting module 1603 is further configured to:
determine, after the phase information is transmitted to the network device, a reference offset direction according to the Doppler shifts;
quantify the reference offset direction based on a fourth bit number, and obtain a fifth quantified result value;
generate a fourth indication message according to the fifth quantified result value; and
transmit the fourth indication message to the network device.

In some examples, the processing module 1602 is further configured to:
obtain a time difference, where the time difference and the Doppler shifts are configured to determine the phase difference of the transmission path.

In some examples, the processing module 1602 is further configured to:
receive the time difference transmitted by the network device;
determine a Doppler spread of the terminal device, and determine the time difference according to the Doppler spread;
determine the time difference according to the tracking reference signal; and
obtain the preset time difference.

In some examples, the processing module 1602 is further configured to:
determine a moving speed of the terminal device;
determine a wavelength of a downlink channel carrier; and
determine the Doppler spread according to the moving speed and the wavelength of the downlink channel carrier.

In some examples, the processing module 1602 is further configured to:
determine a first descriptor value;
determine a time slot interval length of the tracking reference signal, where the time slot interval length is an interval length between a first time slot and a second time slot in a same period in the tracking reference signal; and
process the time slot interval length according to the first descriptor value, and obtain the time difference.

In some examples, the processing module 1602 is further configured to:
determine a second descriptor value;
determine a symbol difference between different orthogonal frequency division multiplexing symbols in the tracking reference signal; and
describe the symbol difference according to the second descriptor value, and obtain the time difference.

In some examples, the processing module 1602 is further configured to:
transmit the time difference to the network device.

In some examples, the processing module 1602 is further configured to:
obtain a third descriptor value; and
process the Doppler shifts according to the third descriptor value, and obtain the phase deflection values of the transmission paths.

In the example, reference is made to the tracking reference signal by the terminal device, such that the phase information of the transmission paths is determined. The phase information is configured to describe the phase condition corresponding to the Doppler shifts of the transmission paths. Then, the phase information is transmitted to the network device, such that the channel information is determined by the network device based on the phase information. As data conversion and quantified for indication are not required for the Doppler shifts of the transmission paths, feedback indication overhead can be effectively reduced, and information transmission efficiency can be improved.

FIG. 17 is a schematic structural diagram of an apparatus for transmitting information according to an example of the disclosure. The apparatus 170 for transmitting information shown in FIG. 17 may include a transceiving module 1701 and a processing module 1702. The transceiving module 1701 may include a transmitting module and/or a receiving module. The transmitting module is configured to achieve a transmission function. The receiving module is configured to achieve a reception function. The transceiving module 1701 may achieve the transmission function and/or the reception function.

The apparatus 170 for transmitting information may be a terminal device, or an apparatus in a terminal device, or an apparatus used in cooperation with a terminal device. Alternatively, the apparatus 170 for transmitting information may be a network device, or an apparatus in a network device, or an apparatus used in cooperation with a network device.

The apparatus 170 for transmitting information is located on a network device, side. The apparatus 170 includes:
the transceiving module 1701 configured to transmit a tracking reference signal to a terminal device, and receive phase information of a transmission path transmitted by the terminal device; and
the processing module 1702 configured to determine channel information according to the phase information.

In some examples, the processing module 1702 is further configured to:
determine a Doppler shift of the transmission path according to the phase information; and
determine the channel information according to the Doppler shift.

In some examples, a plurality of the transmission paths are provided. The transceiving module 1701 is further configured to:
receive a first indication message transmitted by the terminal device, where the first indication message includes: a plurality of first quantified result values, and the first quantified result value is obtained by quantifying phase differences of the transmission paths based on a first bit number;
determine the phase differences corresponding to the corresponding transmission paths according to the first quantified result values; and
use each of the phase differences as the received phase information of each of the transmission paths.

In some examples, a plurality of the transmission paths are provided, and each of the transmission paths corresponds to one of phase differences. The transceiving module 1701 is further configured to:
receive a second indication message transmitted by the terminal device, where the second indication message includes: a second quantified result value, the second quantified result value is obtained by quantifying a target phase difference based on a first bit number, and the target phase difference is determined from a plurality of the phase differences;
determine the target phase difference according to the second quantified result value; and
use the target phase difference as the received phase information of the transmission paths.

In some examples, a plurality of the transmission paths are provided, and each of the transmission paths corresponds to one of phase deflection values. The transceiving module 1701 is further configured to:
receive a plurality of third indication messages transmitted by the terminal device, where the third indication messages include: third quantified result values and fourth quantified result values, the third quantified result values are obtained by quantifying first target processing values based on a second bit number, and the fourth quantified result values are obtained by quantifying second target processing values based on a third bit number;
determine the first target processing values according to the third quantified result values;
determine the second target processing values according to the fourth quantified result values;
determine the corresponding phase deflection values according to the first target processing values and the second target processing values; and
use each of the phase deflection values as the received phase information of each of the transmission paths.

In some examples, the transceiving module 1701 is further configured to:
receive a fourth indication message transmitted by the terminal device, where the fourth indication message includes: a fifth quantified result value, the fifth quantified result value is obtained by quantifying a reference offset direction based on a fourth bit number, and the reference offset direction is determined based on Doppler shifts;
determine the reference offset direction according to the fifth quantified result value; and
conduct target processing on the reference offset direction.

In some examples, the phase information includes: a phase difference of the transmission path, or a phase deflection value of the transmission path.

The processing module 1702 is further configured to:
determine a Doppler shift of the transmission path according to the phase difference of the transmission path; and alternatively,
determine a Doppler shift of the transmission path according to the phase deflection value of the transmission path.

In some examples, the processing module 1702 is further configured to:
obtain a time difference; and
determine a Doppler shift of the transmission path according to the time difference and the phase differences.

In some examples, the time difference is obtained by any one of the following methods:
the time difference transmitted by the terminal device is received;
a Doppler spread of the terminal device is determined, and the time difference is determined according to the Doppler spread;
the time difference is determined according to the tracking reference signal; and
the preset time difference is obtained.

In some examples, the processing module 1702 is further configured to:
determine a moving speed of the terminal device;
determine a wavelength of a downlink channel carrier; and
determine the Doppler spread according to the moving speed and the wavelength of the downlink channel carrier.

In some examples, the processing module 1702 is further configured to:
determine a first descriptor value;
determine a time slot interval length of the tracking reference signal, where the time slot interval length is an interval length between a first time slot and a second time slot in a same period in the tracking reference signal; and
process the time slot interval length according to the first descriptor value, and obtain the time difference.

In some examples, the processing module 1702 is further configured to:
determine a second descriptor value;
determine a symbol difference between different orthogonal frequency division multiplexing symbols in the tracking reference signal; and
describe the symbol difference according to the second descriptor value, and obtain the time difference.

In some examples, the processing module 1702 is further configured to:
transmit the time difference to the terminal device.

In some examples, the processing module 1702 is further configured to:
obtain a third descriptor value; and
process the phase deflection values according to the third descriptor value, and obtain the Doppler shifts of the transmission paths.

In the example, the tracking reference signal is transmitted to the terminal device, the phase information of the transmission paths transmitted by the terminal device is received, and the channel information is determined according to the phase information, such that the channel information may be determined by the network device based on the received phase information uploaded by the terminal device. As data conversion and quantified for indication are not required for the Doppler shifts of the transmission paths, through reception of the network device, feedback indication overhead can be effectively reduced, and information transmission efficiency can be improved.

FIG. 18 is a schematic structural diagram of a communication apparatus according to an example of the disclosure. The communication apparatus 180 may be a network device, or a terminal device (for example, the terminal device in the above method example), or a chip, a chip system or a processor that supports the network device to implement the above method, or a chip, a chip system or a processor that supports the terminal device to implement the above method. The apparatus may be configured to implement the method described in the above method example. Reference may be made to the description in the above method example for details.

The communication apparatus 180 may include one or more processors 1801. The processor 1801 may be a general-purpose processor, a special-purpose processor, etc. For example, the processor may be a baseband processor or a central processing unit. The baseband processor may be configured to process a communication protocol and communication data. The central processing unit may be configured to control the communication apparatus (for example, a base station, a baseband chip, a terminal device, a terminal device chip, a DU, or a CU), execute a computer program, and process data of the computer program.

In some examples, the communication apparatus 180 may further include one or more memories 1802. A computer program 1804 may be stored in the memory. A computer program 1803 may be stored in a processor 1801. The computer program 1804 and/or the computer program 1803 are/is executed by the processor 1801, such that the method according to the above method example is executed by the communication apparatus 180. In some examples, the memory 1802 may further store data. The communication apparatus 180 and the memory 1802 may be arranged separately or integrated with each other.

In some examples, the communication apparatus 180 may further include a transceiver 1805 and an antenna 1806. The transceiver 1805 may be referred to as a transceiving unit, a transceiving machine, a transceiving circuit, etc., and is configured to achieve a transceiving function. The transceiver 1805 may include a receiver and a transmitter. The receiver may be referred to as a reception machine or a reception circuit, and is configured to achieve a reception function. The transmitter may be referred to as a transmission machine or a transmission circuit, and is configured to achieve a transmission function.

In some examples, the communication apparatus 180 may further include one or more interface circuits 1807. The interface circuit 1807 is configured to receive a code instruction and transmit the code instruction to the processor 1801. The processor 1801 runs the code instruction, such that the method according to the above method example is executed by the communication apparatus 180.

In a case that the communication apparatus 180 is a terminal device (for example, the terminal device in the above method example): the processor 1801 is configured to execute step S202 in FIG. 2; steps S302-S303 in FIG. 3; steps S401-S403 in FIG. 4; steps S501-S505 in FIG. 5; steps S602-S607 in FIG. 6; steps S702-S706 in FIG. 7; and steps S802-S804 in FIG. 8. The transceiver 1805 is configured to execute steps S201 and S203 in FIG. 2; steps S301 and S304 in FIG. 3; step S404 in FIG. 4; step S506 in FIG. 5; steps S601 and S608 in FIG. 6; steps S701 and S707 in FIG. 7; and steps S801 and S805 in FIG. 8.

In a case that the communication apparatus 180 is a network device: the processor 1801 is configured to execute step S903 in FIG. 9; steps S1003-S1005 in FIG. 10; steps S1104-S1105 in FIG. 11; steps S1203-S1204 in FIG. 12; steps S1303-S1306 in FIG. 13; steps S1403-S1404 in FIG. 14; or steps S1503-S1507 in FIG. 15. The transceiver 1805 is configured to execute steps S901 and S902 in FIG. 9; steps S1001 and S1002 in FIG. 10; steps S1101 and S1102 in FIG. 11; steps S1201 and S1202 in FIG. 12; steps S1301 and S1302 in FIG. 13; steps S1401 and S1402 in FIG. 14; or steps S1501 and S1502 in FIG. 15.

In one embodiment, the processor 1801 may include the transceiver configured to achieve reception and transmission functions. For example, the transceiver may be a transmission-reception circuit, an interface, or an interface circuit. The transceiving circuit, interface or interface circuit configured to achieve the reception and transmission functions may be separated or integrated. The transceiving circuit, interface or interface circuit may be configured to read and write codes or data. Alternatively, the transceiving circuit, interface or interface circuit may be configured to transmit or transfer a signal.

In one embodiment, the processor 1801 may store a computer program 1803. The computer program 1803 runs on the processor 1801, such that the communication apparatus 180 may execute the method described in the above method example. The computer program 1803 may be cured in the processor 1801. In this case, the processor 1801 may be implemented by hardware.

In one embodiment, the communication apparatus 180 may include a circuit. The circuit may achieve the transmission or reception or communication function in the above method example. The processor and the transceiver described in the disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be manufactured by various IC process technologies, such as a complementary metal oxide semiconductor (CMOS), an n-metal oxide semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus according to the above examples may be the network device or the terminal device (for example, a terminal device in the above method example), which does not limit the scope of the communication apparatus according to the disclosure. A structure of the communication apparatus may not be limited by FIG. 18. The communication apparatus may be an independent device or may be part of a large device. For example, the communication apparatus may be:
(1) an independent integrated circuit (IC), a chip, a chip system, or a subsystem;
(2) a set having one or more ICs, where the IC set may also include a storage component configured to store data and a computer program;
(3) an ASIC, for example, a modem;
(4) a module that may be embedded in other devices;
(5) a receiver, a terminal device, an intelligent terminal device, a cellular phone, a radio device, a handset, a mobile unit, an in-vehicle device, a network device, a cloud device, an artificial intelligence device, etc.; and
(6) a different device.

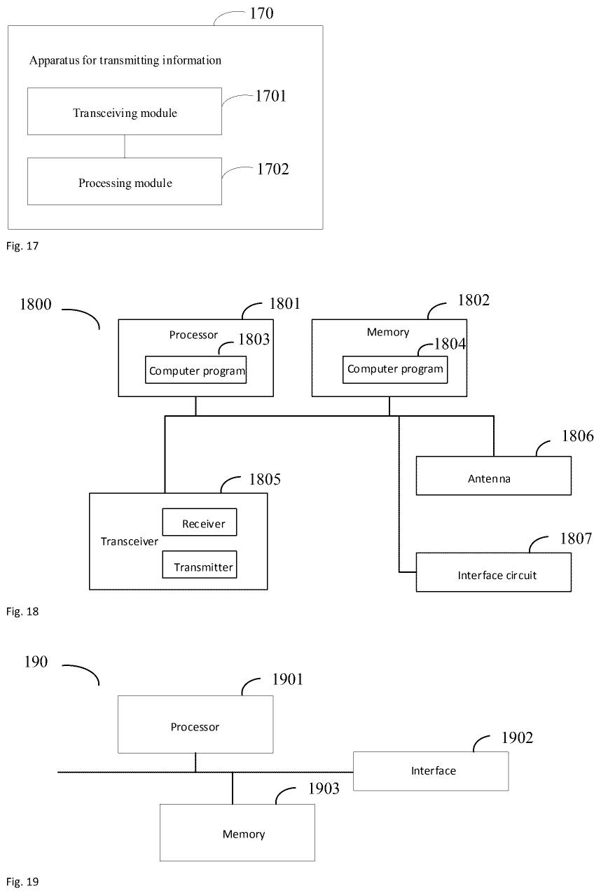

In a case that the communication apparatus may be a chip or a chip system, reference may be made to a schematic structural diagram of the chip shown in FIG. 19. The chip shown in FIG. 19 includes a processor 1901 and an interface 1902. The number of processors 1901 may be one or more. The number of interfaces 1902 may be greater than one.

In a case that the chip is configured to achieve functions of the terminal device (for example, a terminal device in the above method example) in the example of the disclosure:
the interface 1902 is configured to execute step S201 in FIG. 2; step S301 in FIG. 3; step S401 in FIG. 4; step S501 in FIG. 5; step S601 in FIG. 6; step S701 in FIG. 7; step S801 in FIG. 8; step S901 in FIG. 9; step S1001 in FIG. 10; steps S1101 and S1102 in FIG. 11; or steps S1201 and S1204 in FIG. 12.

In a case that the chip is configured to achieve functions of the network device in the example of the disclosure:
the interface 1902 is configured to execute step S1301 in FIG. 13; steps S1401 and S1403 in FIG. 14; or steps S1501 and S1503 in FIG. 15.

In some examples, the chip further includes a memory 1903. The memory 1903 is configured to store a computer program and data that are necessary.

Those skilled in the art may further understand that various illustrative logical blocks and steps listed in the examples of the disclosure may be implemented by electronic hardware, computer software, or a combination of electronic hardware and computer software. Whether the function is achieved by hardware or software depends on specific applications and design requirements of an entire system. Those skilled in the art may achieve the described functions for each particular application through different methods, but such implementation is not considered to fall beyond the protection scope of the examples of the disclosure.

An example of the disclosure further provides a communication system. The communication system includes the communication apparatus as the terminal device and the communication apparatus as the network device in the example of FIG. 17. Alternatively, the communication system includes the communication apparatus as the terminal device (for example, a terminal device in the above method example) and the communication apparatus as the network device in the example of FIG. 19.

The disclosure further provides a non-transitory readable storage medium, which stores an instruction. When the instruction is executed by a computer, functions of any one of the above method examples are achieved.

The disclosure further provides a computer program product. When the computer program product is executed by a computer, functions of any one of the above method examples are achieved.

The above examples may be partially or completely implemented with software, hardware, firmware or their any combinations. When implemented with software, the examples may be partially or completely implemented in the form of a computer program product. The computer program product includes one or more computer programs. When the computer program is loaded and executed on the computer, flows or functions according to the examples of the disclosure are partially or completely generated. The computer may be a general-purpose computer, a special-purpose computer, a computer network, or other programmable apparatuses. The computer program may be stored in a computer-readable storage medium or transmitted from a computer-readable storage medium to another computer-readable storage medium. For example, the computer program may be transmitted from a website, a computer, a server or a data center to another website, another computer, another server or another data center in a wired way (for example, a coaxial cable, an optical fiber, or a digital subscriber line (DSL)) or a wireless way (for example, infrared waves, radio, or microwaves). The computer-readable storage medium may be any available medium that may be accessed by the computer or a data storage device such as an integration server and data center that includes one or more available media. The available medium may be a magnetic medium (for example, a floppy disk, a hard disk, or a magnetic tape), an optical medium (for example, a high-density digital video disc (DVD)), a semiconductor medium (for example, a solid state disk (SSD)), etc.

Those of ordinary skill in the art may understand that numerical symbols such as “first” and “second” involved in the disclosure are only for convenience of description, instead of limiting the scope of the examples of the disclosure, and further indicate a sequence.

“At least one” in the disclosure may also be described as “one or more”, and “a plurality of” may indicate two, three, four or more, which are not limited by the disclosure. In the example of the disclosure, for a technical feature, technical features in the technical feature are distinguished by “first”, “second”, “third”, “A”, “B”, “C”, “D”, etc. The technical features described by the “first”, “second”, “third”, “A”, “B”, “C” and “D” are not in order of succession or order of size.

The correspondence shown in each table in the disclosure may be configured or predefined. Values of information in each table are only illustrative, and may be configured to be other values, which are not limited by the disclosure. When the correspondence between information and all parameters is configured, not all the correspondences indicated in each table have to be configured. For example, in the table in the disclosure, the correspondence shown in some rows does not have to be configured. For another instance, appropriate variation and adjustment may be conducted based on the above table, such as splitting and merging. Names of the parameters indicated by headings in the above tables may also be other names that may be understood by a communication apparatus, and values or representations of the parameters may also be other values or representations that may be understood by the communication apparatus. The above tables may also use other data structures during implementation, such as arrays, queues, containers, stacks, linear tables, pointers, linked lists, trees, graphs, structures, classes, heaps and hash tables.

Predefinition in the disclosure may be understood as definition, predefinition, storage, prestorage, prenegotiation, preconfiguration, curing, or prefiring.

Those of ordinary skill in the art may understand that the units and algorithm steps of the instances described in connection with the examples disclosed here may be implemented in electronic hardware, or a combination of computer software and electronic hardware. Whether the functions are executed in hardware or software depends on specific application and design constraints of the technical solution. Professionals may achieve the described functions for each specific application through different methods, but such implementation is not considered to fall beyond the scope of the disclosure.

Those skilled in the art may clearly understand that, for the convenience and conciseness of description, reference may be made to a corresponding process in the above method example for a specific operation process of the system, apparatus and unit described above, which will not be repeated here.

What are described above are merely specific embodiments of the disclosure, but do not limit the protection scope of the disclosure. Any change or substitution that may be easily conceived by any person skilled in the art within the technical scope of the disclosure should fall within the protection scope of the disclosure. Thus, the protection scope of the disclosure should be subject to the protection scope of the claims.

1. A method for transmitting information, performed by a terminal device, the method comprising:
receiving a tracking reference signal;
determining phase information of a transmission path according to the tracking reference signal; and
transmitting the phase information to a network device.

2. The method according to claim 1, wherein the determining phase information of a transmission path according to the tracking reference signal comprises:
determining a Doppler shift of the transmission path according to the tracking reference signal; and
determining a phase difference or a phase deflection value of the transmission path according to the Doppler shift, wherein the phase difference or the phase deflection value is used as the phase information.

3. The method according to claim 2, wherein a plurality of the transmission paths are provided, and the transmitting the phase information to a network device comprises at least one of the following:
transmitting phase differences corresponding to the plurality of the transmission paths to the network device separately determining that at least one transmission path corresponds to one of the phase differences;
transmitting a target phase difference to the network device, wherein the target phase difference is determined from a plurality of the phase differences determining that at least one transmission path corresponds to one of the phase differences; or
transmitting phase deflection values corresponding to the plurality of the transmission paths to the network device determining that at least one transmission path corresponds to one of the phase deflection values.

4. The method according to claim 3, wherein the method further comprises:
determining a Doppler shift corresponding to each of the transmission paths;
determining a target Doppler shift from a plurality of the Doppler shifts; and
determining a phase difference corresponding to the target Doppler shift from a plurality of the phase differences, and using corresponding phase difference as the target phase difference;
wherein the determining a target Doppler shift from a plurality of the Doppler shifts comprises at least one of the following:
determining a maximum Doppler shift from the plurality of the Doppler shifts, wherein the maximum Doppler shift is used as the target Doppler shift; or
determining an average Doppler shift from the plurality of the Doppler shifts, wherein the average Doppler shift is used as the target Doppler shift.

5. (canceled)

6. The method according to claim 3, wherein the transmitting phase differences corresponding to a plurality of the transmission paths to the network device separately comprises:
quantifying each of the phase differences based on a first bit number, and obtaining a first quantified result value corresponding to each of the phase differences;
generating a first indication message according to a plurality of the first quantified result values; and
transmitting the first indication message to the network device.

7. The method according to claim 3, wherein the transmitting a target phase difference to the network device comprises:
quantifying the target phase difference based on a first bit number, and obtaining a second quantified result value;
generating a second indication message according to the second quantified result value; and
transmitting the second indication message to the network device.

8. (canceled)

9. The method according to claim 3, wherein the transmitting phase deflection values corresponding to a plurality of the transmission paths to the network device comprises:
processing each of the phase deflection values, and obtaining each corresponding first target processing value;
processing each of the phase deflection values, and obtaining each corresponding second target processing value;
quantifying each of the first target processing values based on a second bit number, and obtaining each corresponding third quantified result value;
quantifying each of the second target processing values based on a third bit number, and obtaining each corresponding fourth quantified result value;
generating third indication messages according to the third quantified result values and the corresponding fourth quantified result values; and
transmitting a plurality of the third indication messages to the network device.

10. The method according to claim 2, wherein after the transmitting the phase information to a network device, the method further comprises:
determining a reference offset direction according to the Doppler shift;
quantifying the reference offset direction based on a fourth bit number, and obtaining a fifth quantified result value;
generating a fourth indication message according to the fifth quantified result value; and
transmitting the fourth indication message to the network device.

11. The method according to claim 2, further comprising:
obtaining a time difference, wherein the time difference and the Doppler shift are configured to determine the phase difference of the transmission path; and
transmitting the time difference to the network device;
wherein the time difference is obtained by at least one of the following:
receiving the time difference transmitted by the network device;
determining a Doppler spread of the terminal device, and determining the time difference according to the Doppler spread;
determining the time difference according to the tracking reference signal; and
obtaining a preset time difference.

12. (canceled)

13. The method according to claim 11,
wherein the determining a Doppler spread of the terminal device comprises: determining a moving speed of the terminal device, determining a wavelength of a downlink channel carrier, and
determining the Doppler spread according to the moving speed and the wavelength of the downlink channel carrier;
wherein the determining the time difference according to the tracking reference signal comprises at least one of the following:
determining a first descriptor value, determining a time slot interval length of the tracking reference signal, wherein the time slot interval length is an interval length between a first time slot and a second time slot in a same period in the tracking reference signal, processing the time slot interval length according to the first descriptor value, and obtaining the time difference; or
determining a second descriptor value, determining a symbol difference between different orthogonal frequency division multiplexing symbols in the tracking reference signal, and describing the symbol difference according to the second descriptor value, and obtaining the time difference.

14-16. (canceled)

17. The method according to claim 2, wherein the determining a phase deflection value of the transmission path according to the Doppler shift comprises:
obtaining a third descriptor value; and
processing the Doppler shift according to the third descriptor value, and obtaining the phase deflection value of the transmission path.

18. A method for transmitting information, performed by a network device, comprising:
transmitting a tracking reference signal to a terminal device;
receiving phase information of a transmission path transmitted by the terminal device; and
determining channel information according to the phase information.

19. The method according to claim 18, wherein the determining channel information according to the phase information comprises:
determining a Doppler shift of the transmission path according to the phase information; and
determining the channel information according to the Doppler shift.

20. The method according to claim 18, wherein a plurality of the transmission paths are provided; and the receiving phase information of a transmission path transmitted by the terminal device comprises at least one of the following:
receiving a first indication message transmitted by the terminal device, wherein the first indication message comprises a plurality of first quantified result values, and the plurality of first quantified result values are obtained by quantifying phase differences of the transmission paths based on a first bit number, determining phase differences corresponding to corresponding transmission paths according to the first quantified result values, using each of the phase differences as the received phase information of each of the transmission paths;
determining that at least one transmission path corresponds to one of the phase differences, receiving a second indication message transmitted by the terminal device, wherein the second indication message comprises a second quantified result value, the second quantified result value is obtained by quantifying a target phase difference based on a first bit number, and the target phase difference is determined from a plurality of the phase differences,
determining the target phase difference according to the second quantified result value, and
using the target phase difference as the received phase information of the transmission paths; or
determining that at least one transmission path corresponds to one of the phase deflection values, receiving a plurality of third indication messages transmitted by the terminal device, wherein the third indication messages comprise third quantified result values and fourth quantified result values, the third quantified result values are obtained by quantifying first target processing values based on a second bit number, and the fourth quantified result values are obtained by quantifying second target processing values based on a third bit number, determining the first target processing values according to the third quantified result values;
determining the second target processing values according to the fourth quantified result values, determining corresponding phase deflection values according to the first target processing values and the second target processing values, and using at least one phase deflection value as the received phase information of at least one transmission path.

21-22. (canceled)

23. The method according to claim 18, further comprising:
receiving a fourth indication message transmitted by the terminal device, wherein the fourth indication message comprises a fifth quantified result value, the fifth quantified result value is obtained by quantifying a reference offset direction based on a fourth bit number, and the reference offset direction is determined based on a Doppler shift;
determining the reference offset direction according to the fifth quantified result value; and
conducting target processing on the reference offset direction.

24. The method according to claim 19, wherein the phase information comprises a phase difference of the transmission path, or a phase deflection value of the transmission path; and
the determining a Doppler shift of the transmission path according to the phase information comprises at least one of the following:
determining a Doppler shift of the transmission path according to the phase difference of the transmission path; or,
determining a Doppler shift of the transmission path according to the phase deflection value of the transmission path;
wherein the determining a Doppler shift of the transmission path according to the phase difference of the transmission path comprises:
obtaining a time difference; and
determining a Doppler shift of the transmission path according to the time difference and the phase difference.

25-30. (canceled)

31. The method according to claim 24, wherein the determining a Doppler shift of the transmission path according to the phase deflection value of the transmission path comprises:
obtaining a third descriptor value; and
processing the phase deflection value according to the third descriptor value, and obtaining the Doppler shift of the transmission path.

32-33. (canceled)

34. A communication apparatus, comprising one or more processors and a memory, wherein a computer program is stored in the memory, and the one or more processors are collectively configured to execute the computer program stored in the memory, so as to cause the communication apparatus to perform;
receiving a tracking reference signal;
determining phase information of a transmission path according to the tracking reference signal; and
transmitting the phase information to a network device.

35. A communication apparatus, comprising one or more processors and a memory, wherein a computer program is stored in the memory, and the one or more processors are collectively configured to execute the computer program stored in the memory, such that the method according to claim 18 is executed by the communication apparatus.

36-37. (canceled)

38. A non-transitory computer-readable storage medium, configured to store an instruction, wherein determining that the instruction is executed, the method according to claim 1 is implemented.

39. (canceled)
